(19) United States
(12) Patent Application Publication
(10) Pub. No.: US 2013/0300748 A1
(43) Pub. Date: Nov. 14, 2013

(54) INFORMATION PROCESSING APPARATUS AND METHOD, AND PROGRAM

(71) Applicant: SONY CORPORATION, Tokyo (JP)

(72) Inventors: Takeshi YAEDA, Tokyo (JP); Yuki OKAMURA, Saitama (JP); Tomohiko GOTOH, Kanagawa (JP); Tatsuhito SATO, Tokyo (JP); Yun SUN, Tokyo (JP); Shunsuke MOCHIZUKI, Tokyo (JP); Daisuke MOCHIZUKI, Chiba (JP)

(21) Appl. No.: 13/666,423

(22) Filed: Nov. 1, 2012

(30) Foreign Application Priority Data
Nov. 8, 2011 (JP) 2011244162

(51) Int. Cl. G06T 11/00

(52) U.S. Cl. CPC G06T 11/00
USPC 345/467

(57) ABSTRACT

An image related information obtaining unit that obtains information relating to a predetermined image as image related information, a keyword generating unit that generates a keyword based on the image related information obtained by the image related information obtaining unit, and a display text string candidate generating unit that generates, as a display text string candidate, a text string serving as a candidate for display, using one or more of the keywords generated by the keyword generating unit.

### BACKGROUND

The present technology relates to an information processing apparatus and method, and program, and particularly relates to an information processing apparatus and method, and program wherein a name and description of an object included as a subject in an image such as a photograph or the like can be appropriately obtained.

Upon a person encountering something regarding which that person has no knowledge, that person tends to desire to find out the name thereof and description thereof. Also, upon creating something having no name, e.g., upon engaging in the culinary arts and creating a new food, people tend to desire to name and describe the created thing.

As a response to such desires, a technology exists whereby a photograph of a subject regarding which there is no knowledge or a subject with no name is taken, and a tag relating to the photograph is generated by analyzing the photograph (e.g., Japanese Unexamined Patent Application Publication No. 2008-165303 and Japanese Unexamined Patent Application Publication No. 2010-218227).

### SUMMARY

However, the related art disclosed in Japanese Unexamined Patent Application Publication No. 2008-165303 and Japanese Unexamined Patent Application Publication No. 2010-218227 are used to organize and search for photographs, and the same tag is consistently generated from the same subject. Accordingly, a tag generated in the case of a subject having no name can be used serving as a new name to be given to something with no name, but is not appropriate to use as a description of something with no name. Further, in the case that a subject has a name and description, but the name and description are not available, finding out the name and description of the object from a generated tag is extremely difficult.

It has been found desirable to enable the name and description of an object included as a subject in an image, such as a photograph or the like, to be appropriately obtained.

An information processing apparatus according to an embodiment of the present technology includes an image related information obtaining unit that obtains information relating to a predetermined image as image related information, a keyword generating unit that generates a keyword based on the image related information obtained by the image related information obtaining unit, and a display text string candidate generating unit that generates, as a display text string candidate, a text string serving as a candidate for display, using one or more of the keywords generated by the keyword generating unit.

The information processing apparatus may further include a display text string selecting unit that selects a text string to be displayed as the display text string, from the display text string candidates generated by the display text string candidate generating unit.

The information processing apparatus may further include a communication unit that correlates the display text string selected by the display text string selecting unit and the predetermined image data, and transmits to another information processing apparatus.

The display text string selecting unit may further calculate scores as to each of the display text string candidates, and select the display text string based on the scores calculated as to each of the display text string candidates.

The information processing apparatus may further include a communication unit that receives the predetermined image data transmitted from the other information processing device, with the image related information obtaining unit, the keyword generating unit, and the display text string candidate generating unit each executing processing, based on the predetermined image data received by the communication unit, and the communication unit transmitting the display text string candidates generated by the display text string candidate generating unit to the other information processing apparatus.

The image related information obtaining unit may use the analysis results of the predetermined image data to generate the image related information in a predetermined language, with the keyword generating unit generating the keywords in the predetermined language and the display text string candidate generating unit generating the display text string candidates in the predetermined language.

The image related information obtaining unit may further include an image analyzing information obtaining unit that obtains information indicating the analysis results of the predetermined image data, as image analysis information which is a type of the image related information; an image appended information obtaining unit that obtains information appended to the predetermined image data, as image appended information which is a type of the image related information; and a photographer-contributor information obtaining unit that obtains information about the photographer of the predetermined image or the contributor to a community to which the predetermined image belongs, as photographer-contributor information which is a type of the image related information.

The image related information obtaining unit may further include an image attached information obtaining unit that obtains information attached to the predetermined image, as image attached information which is a type of image related information; and a viewer-viewing environment information obtaining unit that obtains information relating to the viewer of the predetermined image in the community to which the predetermined image belongs, or information relating to the viewing environment of the predetermined image, as viewer-viewing environment information which is a type of the image related information.

The keyword generating unit may generate, as the keyword, the image related information itself, or the image related information that is converted using a predetermined rule or database.

The display text string candidate generating unit may generate, as the display text string candidate, the keyword itself, a text string linking a plurality of the keywords, or the keyword that has been converted using a predetermined rule or database.

The information processing method and program according to an embodiment of the present technology is a method and program corresponding to the information processing device according to an embodiment of the present technology described above.

With the information processing apparatus and method and program according to an embodiment of the present technology, information relating to a predetermined image is obtained as image related information, keywords are generated based on the obtained image related information, and using one or more of the generated keywords, text strings serving as candidates for display are generated as display text string candidates.

As described above, according to the present technology, the name and description of an object included as a subject in an image such as a photograph or the like can be appropriately obtained.

### BRIEF DESCRIPTION OF THE DRAWINGS

FIG. 1 is a block diagram illustrating a configuration of a display text string automatic generating system to which a first embodiment of the present disclosure is applied;

FIG. 2 is a block diagram illustrating an example of a functional configuration of a server in a text string automatic generating system;

FIG. 3 is a flowchart describing the processing relation between a server and a terminal apparatus;

FIG. 4 is a diagram illustrating an example of photograph related information obtained by a photograph related information obtaining unit;

FIG. 5 is a diagram illustrating an example of keywords generated by a keyword generating unit;

FIG. 6 is a diagram illustrating an example of a display text string candidate generated by a display text string candidate generating unit;

FIG. 7 is a diagram illustrating an example of a display text string selected by a display text string selecting unit;

FIG. 8 is a diagram illustrating an example of a display text string and photograph displayed by a terminal apparatus;

FIG. 9 is a flowchart describing the processing relation between a server and a terminal apparatus;

FIG. 10 is a diagram illustrating an example of photograph related information obtained by a photograph related information obtaining unit;

FIG. 11 is a diagram illustrating an example of an operating image to select a display text string;

FIG. 12 is a diagram illustrating an example of a menu at an overseas restaurant;

FIG. 13 is a flowchart describing the processing relation between a server and a terminal apparatus; and

FIG. 14 is a diagram illustrating a display text string overlaying a photograph of a menu.

### DETAILED DESCRIPTION OF EMBODIMENTS

As embodiments of the present technology, three embodiments (hereafter called first through third embodiments) will be described in the order below.

1. First Embodiment (Example of automatic generation of display text string at time of viewing photographs)
2. Second Embodiment (Example of automatic generation of display character string candidates at time of uploading photographs)
3. Third Embodiment (Example of automatic generation of display character strings using a menu translating application)

Embodiments according to the present technology sill be described below with reference to the appended diagrams.

### First Embodiment

### Configuration Example of Text String Automatic Generating System 1 to which the Present Technology is Applied

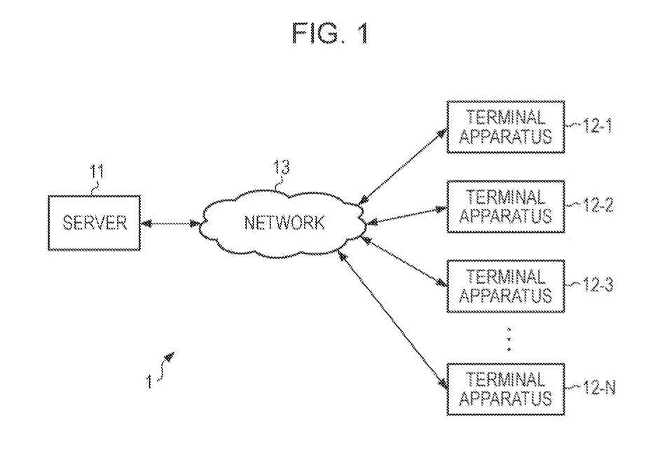

FIG. 1 is a block diagram illustrating a configuration of a text string automatic generating system to which the first embodiment according to the present technology is applied.

The text string automatic generating system 1 in FIG. 1 is made up of a server 11, terminal apparatuses 12-1 through 12-N (N is an arbitrary integer value of 1 or greater), and a network 13. Note that hereafter, in the case that the terminal apparatuses 12-1 through 12-N do not have to be individually distinguished, these will be summarily called the terminal apparatus 12.

The server 11 is a server that provides or supports a predetermined SNS (Social Network Service), and according to the present embodiment has at least the following functions. That is to say, the server 11 has a function to receive and record image data uploaded from an optional terminal apparatus 12 connected to the network 13. Also, the server 11 has a function to analyze the recorded image data and generate names and descriptions to be processed, using objects included in the image as processing targets. The term “generated” as used here includes not only creating and appending a new name or new description in the case that something with no name is to be processed, but also includes expressing a name or description, in the case that which is to be processed has a name or description but the name or description thereof is not available, such that a state in which the name or description thereof is not available is avoided. Also, the server 11 has a function to transmit data indicating the generated name and description, together with the recorded image data, to an optional terminal apparatus 12. Further details of the server 11 will be described later.

The terminal apparatus 12 is operated by a user that uses an SNS provided or supported by the server 11, and can exchange various types of information with the server 11 and other terminal apparatuses 12 that are connected to the network 13. For example, the terminal apparatus 12 can upload the image data to the server 11 via the network 13, in order for the user using the SNS and other users to share the images such as photographs. Thus, the image data uploaded to the server 11 is transmitted by the server 11, together with the data indicating the object name and description generated, to the other terminal apparatuses 12. In other words, the image data uploaded to the server 11 from the other terminal apparatuses 12 is transmitted by the server 11, together with the data indicating the object name and description generated, to the other terminal apparatuses 12. In such a case, the terminal apparatus 12 receives the data therein, and displays the object name and description together with the image on a display or the like.

The network 13 according to the present embodiment is the Internet, for example. Note that hereafter, the text string automatic generating system 1 processes, of image data, particularly photograph data. In this case, the object is a subject included in a photograph.

### Configuration Example of Server 11

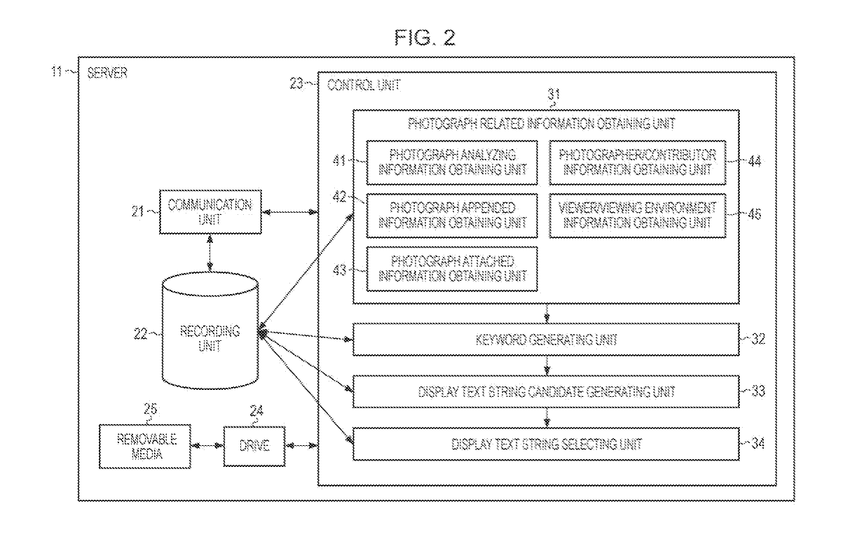

FIG. 2 is a block diagram illustrating a functional configuration example of the server 11 of the text string automatic generating system 1 in FIG. 1.

The server 11 is configured so as to include a communication unit 21, recording unit 22, control unit 23, drive 24, and drive 25.

The communication unit 21 is made up of a network interface or the like, for example, and exchanges various types of information by communicating with the terminal apparatus 12 via the network 13. For example, the communication unit 21 receives photograph data that is transmitted from the terminal apparatus 12. Also, the communication 21 reads out from the recording unit 22 the data indicating the subject name and description included in the photograph, and transmits this to the terminal apparatus 12 via the network 13. Also, the communication unit 21 correlates the photograph data and the data indicating the subject name and description included in the photograph as appropriate, and transmits this to the terminal apparatus 12 via the network 13.

The recording unit 22 recording various types of data is configured of a hard disk or non-volatile memory or the like, for example. For example, the recording unit 22 records the photograph data received by the communication unit 21. Also, the recording unit 22 records data used for processing by the control unit 23, data generated by the control unit 23, and the like, as appropriate.

The control unit 23 is made up of a CPU (Central Processing Unit), ROM (Read Only Memory), and RAM (Random Access Memory), and the like, for example. The CPU executes various types of programs according to a program recorded in the ROM, or a program loaded in the RAM from the recording unit 22. Data or the like used for the CPU to execute various types of processing is also stored in the RAM, as appropriate.

The control unit 23 functionally has a photograph related information obtaining unit 31, keyword generating unit 32, display text string candidate generating unit 33, and display text string selecting unit 34.

The photograph related information obtaining unit 31 obtains various types of information relating to the photograph recorded in the recording unit 22 (hereafter this information is summarily called photograph related information). For example, information indicating analysis results of a photograph by a photograph analyzing engine (hereafter called photograph analyzing information) and information of the photograph date and time or the like and appended to the photograph (hereafter called photograph appended information) is obtained as types of photograph related information. Also, for example, information that is information of a SNS group, community, or the like (hereafter called community) to which the photograph belongs, and that is attached to the photograph (hereafter called photograph attachment information), information relating to a photographer or contributor (hereafter called photographer/contributor information), information relating to one who views or a viewing environment (hereafter called viewer/viewing environment information) and the like are obtained as types of photograph related information.

The photograph related information obtaining unit 31 is configured so as to include a photograph analyzing information obtaining unit 41, photograph appended information obtaining unit 42, photograph attachment information obtaining unit 43, photographer/contributor information obtaining unit 44, and viewer/viewing environment information obtaining unit 45, in order to obtain various types of photograph related information as described above.

The photograph analyzing information obtaining unit 41 obtains photograph analyzing information that is obtained by various types of photograph analyzing engines analyzing the photograph recorded in the recording unit 22. The installation position of the photograph analyzing engines is within the server 11 here, but this position is not limited and the location is optional. The server 11 may be configured as a cloud system with multiple apparatuses.

Also, the types of photograph analyzing engines are not particularly limited, but according to the present embodiment, the following photograph analyzing engines are used.

For example, according to the present embodiment, a photograph analyzing engine for physical object recognition is used. Physical object recognition results of what object the subject is, such as whether the subject included in the photograph is, for example, a meal, or a car, or the like, is included in the photograph analyzing information obtained by the photograph analyzing engine for physical object recognition.

Also, for example, according to the present embodiment, a photograph analyzing engine for facial/personal recognition is used. Facial/personal recognition results such as information of the position and angle of a face, emotion, age, gender, and so forth of a person included in the photograph, and information identifying the person, or the like, is included in the photograph analyzing information obtained by the photograph analyzing engine for facial/personal recognition.

Also, for example, according to the present embodiment, a photograph analyzing engine for meal recognition is used. Meal recognition results such as the position, category, name, ingredients, calories, nutrition, and so forth of the meal included in the photograph is included in the photograph analyzing information obtained by the photograph analyzing engine for meal recognition.

Also, for example, according to the present embodiment, a photograph analyzing engine for composition analysis is used. Composition analysis results such as the distribution of the subjects in the photograph and subjects photographs as the main subjects and so forth are included in the photograph analyzing information obtained by the photograph analyzing engine for composition analysis.

Also, for example, according to the present embodiment, a photograph analyzing engine for scene analysis is used. Scene analysis results such as the whether the photograph is a scenery photograph or a photograph of a person and so forth are included in the photograph analyzing information obtained by the photograph analyzing engine for scene analysis.

Also, for example, according to the present embodiment, a photograph analyzing engine for focus region recognition is used. Focus region recognition results such as a region in the photograph that is likely to be focused upon by the viewer and so forth is included in the photograph analyzing information obtained by the photograph analyzing engine for focus region recognition.

There are cases where such various types of photograph analyzing engines are used in combination. In this case, the photograph analyzing information obtaining unit 41 obtains various types of photograph analyzing information obtained by each of the various types of photograph analyzing engines used in combination.

The photograph appended information obtaining unit 42 obtains photograph appended information such as the shooting date and time, shooting location, shooting mode, and so forth of the photograph.

The date and time and the season and so forth when the photograph was shot can be found from the shooting date and time. The shooting location is position information based on a GPS (Global Positioning System) or the like, and the name and address and the like of the location where the photograph is shot can be found. The shooting mode is the shooting mode of the camera at the time of shooting a photograph. For example, in the case that the shooting mode indicates scenery mode, we can see that a scenery photograph has been shot. Also, for example, in the case that the shooting mode indicates portrait mode, we can see that a photograph of a person has been shot.

The photograph attached information obtaining unit 43 obtains photograph attached information such as a community to which the photograph belongs, and tags or comments appended to the photographs, and so forth.

Information of the community to which the photograph belongs is information of an SNS or the like to which the photograph is uploaded, and can change according to the response of a contributor or viewer. A tag appended to the photograph indicates a tag appended by the user shooting the photograph, or a general feature of the photograph such as the photograph title name, that has been appended from knowledge of the user in order to search or organize the photographs. A comment appended to the photograph is a comment appended by the community to which the photograph is uploaded, or an evaluation comment such as “like”, or the like, and changes appropriately according to the appending timing.

Accordingly, the keyword generating unit 32 described later can generate a keyword that can change according to the reaction of a contributor or viewer, or a keyword that can change according to the timing, based on the photograph attached information obtained by the photograph attached information obtaining unit 43.

The photographer/contributor information obtaining unit 44 obtains photographer/contributor information which is account information or the like of a community to which the photographer or contributor of a photograph belongs. Note that information such as the name, addresses, preferences, and so forth of the photographer or contributor using the community is included in the account information.

The viewer/viewing environment information obtaining unit 45 obtains viewer/viewing environment information which is account information of the community or the like to which the viewer of the photograph belongs, information of the viewing environment, and so forth.

Depending on the photographer/contributor information and the viewer/viewing environment information, the relations between the photographer or contributor and the viewer, or connections within the community, or the like, can be understood. The later-described keyword generating unit 32 uses this information, whereby keywords can be generated that differ by photographer or contributor, or by viewer.

The keyword generating unit 32 generates a keyword, based on various types of photograph related information obtained by the photograph related information obtaining unit 31. The generated keyword may be the photograph related information itself, or may be a keyword wherein the photograph related information has been modified using predetermined rules or a database. Also, one keyword may be generated from multiple pieces of photograph related information, and multiple keywords may be generated from one piece of photograph related information. In either case, as described above, even with the same subject, different photograph related information can be obtained according to the situation, whereby different keywords are generated for the same subject according to the situation.

For example, a word describing the environment or a situation of an object in the photograph from the overall photograph can be generated as a keyword. Also, for example, a word relating to the time, place, or environment of the time of shooting can be generated as a keyword. Also, for example, a word relating to the community to which the photograph belongs can be generated as a keyword. Note that a word relating to the community or the like means a word indicating the name of an album to which a photograph belongs in a community, or the like, or a word that is popular in the community at the time of shooting or contributing (a so-called buzz word), or the like. Also, for example, a word relating to the photographer or viewer can be generated as a keyword.

The display text string candidate generating unit 33 uses one or more keywords generated by the keyword generating unit 32, and generates a text string serving as the name or description of the subject included in the photograph as the display text string candidate. The generated display text string candidate may be the keyword itself, or may be multiple keywords linked together. Also, the generated display text string candidate may be a keyword wherein the keyword has been modified using predetermined rules or a database. In any case, as described above, even with the same subject, different words are generated as keywords according to the situation, whereby different display text string candidates are generated according to the situation, even as to the same subject.

As an example of a display text string candidate, for example, a text string combining a keyword which is a noun that described the target itself, and a keyword which is an adjective expressing the state or situation of the target, can be generated as the display text string candidate.

Also, for example, a text string combining only nouns can be generated as the display text string candidate. Note that in the case that a text string combining only nouns is generated as the display text string candidate, a natural text string can be generated by placing a noun that describes the target itself at the end of the text string.

Also, for example, a text string wherein a keyword is inserted into a predetermined template can be generated as a display text string candidate. Note that a template called “AA-type BB (e.g., Thai-type curry)”, for example, may be used as a predetermined template. In this case, a keyword expressing a geographical location is inserted into “AA”, and a keyword which is a noun describing the target itself is inserted into “BB”, whereby the display text string candidate is generated.

The display text string selecting unit 34 selects, from multiple display text string candidates generated by the display text string candidate generating unit 33, the optimal display text string to become the text string subject to display, according to predetermined rules.

As a predetermined rule, a rule can be employed wherein, for example, a score is calculated as to each of the generated display text string candidates, and the optimal display text string is selected based on these scores. In the case of displaying one display text string as to the overall photograph, a display text string is selected from all of the generated display text string candidates. Conversely, in the case of displaying a display text string as to a predetermined region of the photograph, a display text string is selected from the display text string candidates generated from the keywords that are generated from the photograph related information obtained from the predetermined region.

Note that in the case that the display text string does not have to be selected, e.g. in the case of pre-processing when not being viewed or the like, all of the generated display text string candidates are recorded in the recording unit 22. Also, in the case that a user manually selects a display text string, the generated display text string candidates are all displayed. In this case, the score calculation is omitted.

As a score calculation method, for example, a first calculating method, where a score is calculated according to the length of the text string of the display text string candidate, can be employed. In many cases of the display text string being displayed on a display or the like of the terminal apparatus 12, the display region is limited. Accordingly, a numerical value that has the number of characters of the display text string candidate subtracted from the number of displayable character numbers in the display region may be calculated as the score. In this case, of the calculated scores, the display text string candidate appended with the greatest score that is 0 or greater, i.e. the display text string candidate having the shortest text string, is selected as the display text string. Note that an arrangement may be made wherein the display text string candidate having the longest text string may be selected.

Also, as another score calculating method, for example a second calculating method, where a score is calculated according to the keywords included in the display text string candidate, may be employed. In the case of describing a subject included in a photograph, it may be determined that using a larger number of keyword may be easier to understand. Accordingly, the score may be calculated according to the number of keywords included in the display text string candidate. In this case, the display text string candidate appended with the greatest score, i.e. the display text string candidate in which more keywords are included, may be selected as the display text string. Note that the display text string candidate including fewer keywords may be selected.

Also, as another score calculating method, for example, a third calculating method, where a score is appended to the photograph related information according to the type of photograph related information obtained by the photograph related information obtaining unit 31, and the display text string candidate score is calculated based on this score, may be employed. For example, in the case of viewing photographs uploaded to the server 11 providing an SNS, of the keywords generated based on the photograph related information, the display text string candidates generated based on keywords including more photograph attached information, photographer/contributor information, or viewer/viewing environment information will include more information that is useful to the user of the SNS. Accordingly, of the photograph related information, the scores appended to the photograph attached information, photographer/contributor information, or viewer/viewing environment information are greater than the scores appended to the photograph analyzing information and photograph appended information.

Also, scores are appended as to keywords generated based on the photograph related information. That is to say, the sum value of the score appended to the photograph related information which is the basis of keyword generation becomes the score of the keyword. Further, the score of the display text string candidate generated based on the keywords is calculated. That is to say, the sum value of the score appended to the keyword which is the basis of display text string candidate generation becomes the score of the display text string candidate. In this case, the display text string candidate to which the greatest score is appended, i.e. the display text string candidate including more photograph attached information, photographer/contributor information, or viewer/viewing environment information is selected as the display text string. Note that the type of photograph related information that appends a greater score may be changed.

Further, a calculating method of a score appropriately combining two or more optional methods of the first through third calculating method may be employed. For example, a score may be calculated again with the first calculating method as to a display text string candidate having a larger score out of the scores calculated by the third calculating method. Thus, the display text string can be selected by the length of the text string while considering the meaning of the display text string.

Data used for processing in each of the control units 23 and data generated by each of the control units 23 are recorded in the recording unit 22 as appropriate. Accordingly, the photograph to be processed may not have to be set for processing again, and the same keyword may not have to be generated again, enabling efficient processing.

The drive 24 drives the removable media 25 such as a magnetic disc, optical disc, magneto-optical disc, or semiconductor memory.

### Automatic Generating Processing of Display Text String at Time of Photograph Viewing

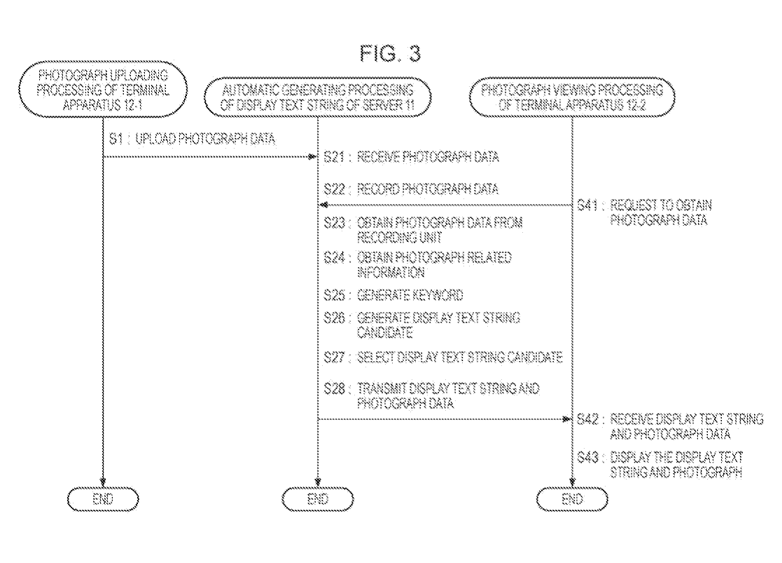

Next, the relation of processing between the server 11 and terminal apparatus 12 in the case of photograph data recorded on the server 11 being viewed by the user of a predetermined terminal apparatus 12 will be described with reference to FIG. 3.

FIG. 3 is a flowchart describing the relation in processing between the server 11 and terminal apparatus 12.

In the example in FIG. 3, the data of the photograph uploaded to the server 11 by an optional terminal apparatus 12 (in the case of FIG. 3, terminal apparatus 12-1) is received by another terminal apparatus 12 (in the case of FIG. 3, terminal apparatus 12-2), and the photograph can be viewed by the user of the terminal apparatus 12-2. On the server 11, one or more display text strings are automatically generated. Thus, the processing executed by the terminal apparatus 12-1 is called photograph uploading processing, and processing executed by the terminal apparatus 12-2 is called photograph viewing processing. Also, the processing executed by the server 11 is called display text string automatic generating processing at time of photograph viewing.

In step S1, the terminal apparatus 12-1 uploads the photograph data to the server 11.

That is to say, from the perspective of the server 11, in step S21 the communication unit 21 of the server 11 receives the photograph data from the terminal apparatus 12-1.

In step S22, the recording unit 22 of the server 11 records the photograph data received by the communication unit 21 in the processing in step S21.

Thus, while in the state of the photograph data having been recorded in the recording unit 22 of the server 11, in step S41 the terminal apparatus 12-2 accesses the server 11 and requests the server 11 to obtain the photograph data recorded by the recording unit 22 of the server 11 in the processing in step S22.

In step S23, the photograph related information obtaining unit 31 of the server 11 obtains the photograph data requested by the terminal apparatus 12-2 from the recording unit 22.

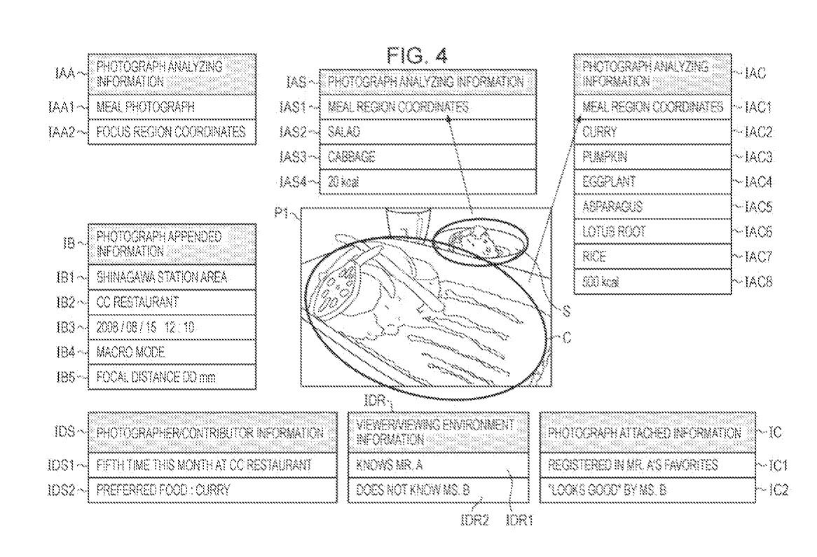

In step S24, the photograph related information obtaining unit 31 of the server 11 obtains photograph related information that relates to the photograph data obtained in the processing in step S23. Details of the processing in step S24 such as the obtained photograph related information will be described later with reference to FIG. 4.

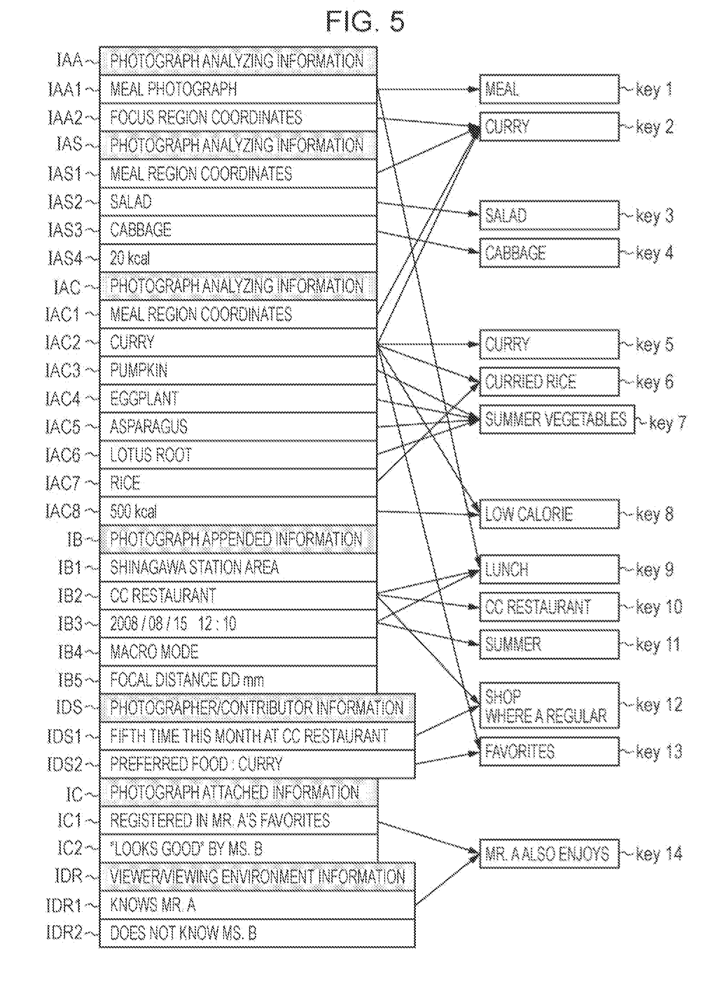

In step S25, the keyword generating unit 32 of the server 11 generates a keyword based on the photograph related information obtained in the processing in step S24. Details of the processing in step S25, such as the keyword to be generated and the generating method thereof, will be described later with reference to FIG. 5.

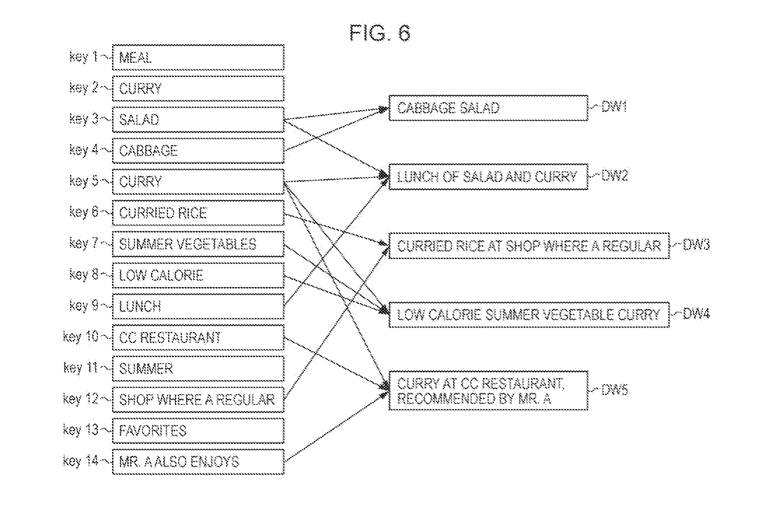

In Step S26, the display text string candidate generating unit 33 of the server 11 uses the keyword generated in the processing in step S25 to generate the display text string candidate. Details of the processing in step S26, such as the display text string candidate to be generated and the generating method thereof, will be described later with reference to FIG. 6.

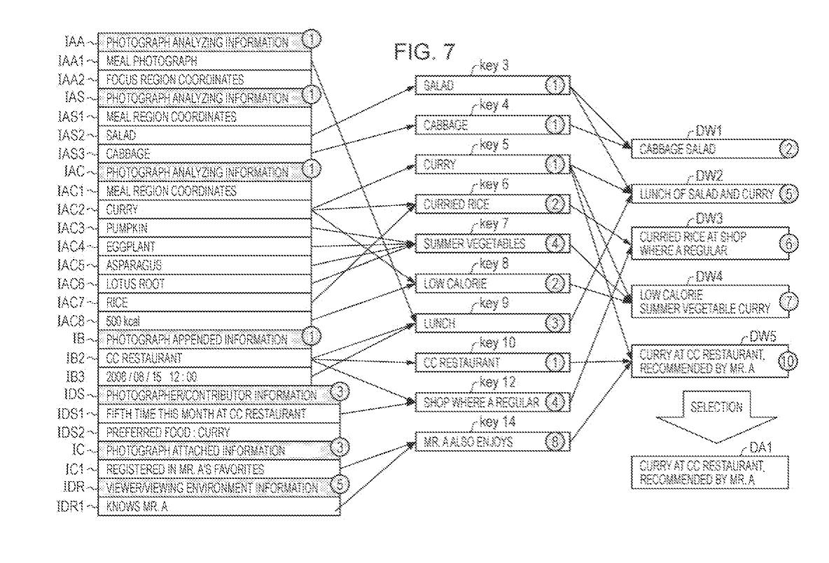

In step S27, the display text string selecting unit 34 of the server 11 selects a display text string from the display text string candidates generated in the processing in step S26. Details of the processing in step S27, such as the display text string to be selected and the selection method thereof, will be described later with reference to FIG. 7.

In step S28, the communication unit 21 of the server 11 correlates the display text string selected in the processing in step S27 and the photograph data, and transmits this to the terminal apparatus 12-2.

Upon the display text string and photograph data being transmitted, the terminal apparatus 12-2 executes the processing in step S42. That is to say, in step S42, the terminal apparatus 12-2 receives the display text string and the photograph data.

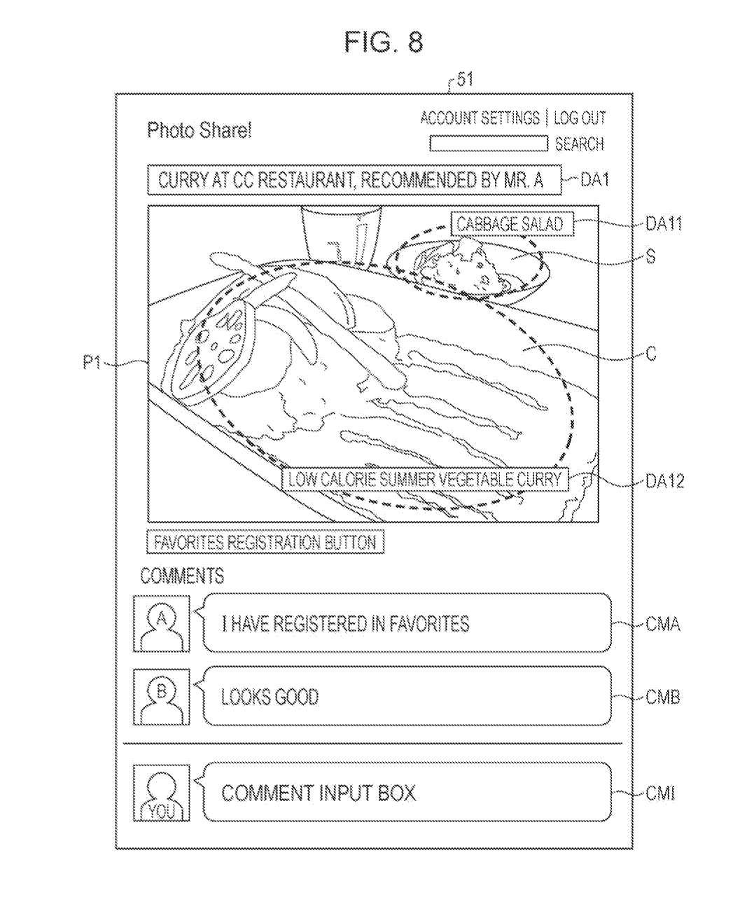

In step S43, the terminal apparatus 12-2 displays the display text string and photograph. Details of the display text string and photograph displayed on the terminal apparatus 12-2 will be described later with reference to FIG. 8.

Thus, the processing of the server 11 and terminal apparatus 12 is ended.

Further, details of the processing in steps S24 through S27 by the server 11 and the processing in step S43 by the terminal apparatus 12-2 will be described with reference to FIGS. 4 through 8.

### Photograph Related Information

Upon the photograph data being obtained as described above (step S23), photograph related information such as that shown in FIG. 4 can be obtained by the photograph related information obtaining unit 31 (step S24).

FIG. 4 is a diagram illustrating an example of photograph related information obtained by the photograph related information obtaining unit 31 in the processing in step S24.

The photograph P1 in FIG. 4 is a photograph corresponding to the data obtained by the recording unit 22 in the processing in step S23. The photograph P1 includes, as the object regarding which automatic generating processing of a display text string is to be performed at the time of viewing the photograph, a subject C which is curried rice and a subject S that is salad.

The photograph analyzing information obtaining unit 41 obtains information IAA1 that indicates a photograph of a meal (hereafter called meal photograph information IAA1), and photograph analyzing information IAA that includes focus region coordinate information IAA2, as the photograph analyzing information in the photograph P1.

Specifically, the photograph analyzing engine performs object recognition processing, and recognizes that the subject included in the photograph P1 is a meal. Also, the photograph analyzing engine performs focus region recognition processing, recognizes the region of the subject C which is curried rice that is disposed at the center of the region of the photograph P1 as the focus region, and obtains the coordinates of the focus region (these coordinates are the coordinates at the center of the screen, and hereafter will be called focus region coordinates). Thus, the meal photograph information (information expressing that the target photograph is a photograph of a meal) IAA1 and the focus region coordinate information IAA2 are included in the photograph analyzing information IAA.

Also, the photograph analyzing information obtaining unit 41 obtains photograph analyzing information IAS, which includes meal region coordinate information IAS1, salad information (information expressing that the category of the subject S is salad) IAS2, cabbage information (information expressing that the ingredient of the subject S is cabbage) IAS3, and 20 kcal information (information expressing that the calorie count of the subject S is 20 kcal) IAS4.

Specifically, the photograph analyzing engine performs meal recognition processing, and obtains the position of the subject S (the coordinates on the upper right portion of the screen, and hereafter called the meal region coordinates). Also, the photograph analyzing engine performs meal recognition processing, and recognizes the category, ingredients, and calorie count of the subject S. Thus, meal region coordinate information IAS1, salad information IAS2, cabbage information IAS3, and 20 kcal information IAS4 are included in the photograph analyzing information IAS.

Also, the photograph analyzing information obtaining unit 41 obtains, as photograph analyzing information IAC as to the subject C of the curried rice included in photograph P1, meal region coordinate information IAC1, curry information (information expressing that the category of the subject C is curry) IAC2, pumpkin information (information expressing that an ingredient of the subject C is pumpkin) IAC3, eggplant information (information expressing that an ingredient of the subject C is eggplant) IAC4, asparagus information (information expressing that an ingredient of the subject C is asparagus) IAC5, lotus root information (information expressing that an ingredient of the subject C is lotus root) IAC6, rice information (information expressing that an ingredient of the subject C is rice) IAC7, and 500 kcal information (information expressing that the calorie count of the subject C is 500 kcal) IAC8.

Specifically, the photograph analyzing engine performs meal recognition processing, and obtains the position of the subject C (coordinates at the center of the screen). Also, the photograph analyzing engine performs meal recognition processing, and recognizes the category, ingredients, and calorie count of the subject C. Thus, meal region coordinate information IAC1, curry information IAC2, pumpkin information IAC3, eggplant information IAC4, asparagus information IAC5, lotus root information IAC6, rice information IAC7, and 500 kcal information IAC8 are included in the photograph analyzing information IAC.

Also, the photograph appending information obtaining unit 42 obtains photograph appending information IB, as photograph appending information of the photograph P1, including Shinagawa station area information (information expressing that the shooting location of the target photograph is in the area of Shinagawa station) IB1, CC restaurant information (information expressing that the name of the shooting location of the target photograph is CC restaurant) IB2, 2008/08/15 12:10 information (information expressing that the shooting date/time of the target photograph is 2008/08/15 12:10) IB3, macro mode information (information expressing that the shooting mode of the target information is macro mode) IB4, and focal distance DDmm information (information expressing that the focal distance of the target photograph is DDmm) IB5.

Specifically, the shooting location where the photograph P1 is shot, and the name and date/time of the shooting location, shooting mode, and focal distance, are obtained. Thus, Shinagawa station area information IB1, CC restaurant information IB2, 2008/08/15 12:10 information IB3, macro mode information IB4, and focal distance information DDmm information IB5 is included in the photograph appended information IB.

Also, as photograph attachment information of the photograph P1, the photograph attachment information obtaining unit 43 obtains photograph attachment information IC which includes message information IC1 of “register in Mr. A's favorites” and message information IC2 of “‘Looks good’ by Ms. B”.

Specifically, status in the community to which the photograph P1 has been uploaded, and comments appended in the community to which the photograph P1 has been uploaded, are obtained. Thus, photograph attachment information IC including the message information IC1 of “register in Mr. A's favorites” and message information IC2 of “‘Looks good’ by Ms. B” are included in the photograph attachment information IC.

Also, the photographer/contributor information obtaining unit 44 obtains, as photographer/contributor information of the photograph P1, photographer/contributor information IDS including message information IDS1 of “shooting a photograph at CC restaurant for the fifth time this month” and message information IDS2 of “favorite food is curry”.

Specifically, information of the location and number of times that a photograph has been shot, and favorite meal information, of the photographer or contributor (i.e. information of the user of the terminal apparatus 12-1 in this case) is obtained from the account information thereof. Thus, the message information IDS1 of “shooting a photograph at CC restaurant for the fifth time this month” and message information IDS2 of “favorite food is curry” are included in the photographer/contributor information IDS.

Also, the viewer/viewing environment information obtaining unit 45 obtains the viewer/viewing environment information IDR, which includes, as the viewer/viewing environment information of the photograph P1, the message information IDR1 of “Knows Mr. A” and the message information IDR2 of “Does not know Ms. B”.

Specifically, the viewer and contributor relationship and connection through SNS can be obtained from the account information of the SNS to which the viewer (i.e., in the present case, the user of the terminal apparatus 12-2) belongs. Thus, the message information IDR1 of “Knows Mr. A” and the message information IDR2 of “Does not know Ms. B” are included in the viewer/viewing environment information IDR.

### Keywords

Also, as described above, upon the photograph related information illustrated in FIG. 4 being obtained (step S24) by the photograph related information obtaining unit 31, keywords such as illustrated in FIG. 5 are generated by the keyword generating unit 32 (step S25).

FIG. 5 is a diagram illustrating an example of keywords generated by the keyword generated unit 32 in the processing in step S25.

On the left side of FIG. 5 is illustrated an example of the photograph related information obtained by the photograph related information obtaining unit 31. On the right side of FIG. 5 is illustrated an example of keywords generated based on the photograph related information.

The keyword generating unit 32 recognizes “meal” as the state of the overall photograph P1 from the meal photograph information IAA1 included in the photograph analyzing information IAA, and generates a keyword key 1 of the word “meal”.

Also, the keyword generating unit 32 recognizes “curry” from the focus region coordinate information IAA2 included in the photograph analyzing information IAA, the meal region coordinate information IAS1 included in the photograph analyzing information IAS, and the meal region coordinate information IAC1 and curry information IAC2 included in the photograph analyzing information IAC, and generates the keyword key 2 of the word “curry”.

Specifically, the meal region coordinate information IAC1 is included in the focus region coordinate information IAA2, whereby the main subject in the photograph P1 is recognized as “curry”, and the word indicating “curry” is generated as the keyword key 2.

Also, the keyword generating unit 32 recognizes “salad” from the salad information IAS2 included in the photograph analyzing information IAS, and generates the keyword key 3 of the word “salad”.

Specifically, the salad information IAS2 indicating the meal category is recognized itself as the keyword, and the word indicating “salad” is generated as the keyword key 3.

Also, the keyword generating unit 32 recognizes “cabbage” from the salad information IAS3 included in the photograph analyzing information IAS, and generates the keyword key 4 of the word “cabbage”.

Specifically, if there is photograph related information indicating an ingredient covering a large region in the photograph related information indicating the meal ingredients, such information is employed as a keyword. In the present case, the photograph related information indicating the ingredient of the subject S of salad is only the cabbage information IAS3. Accordingly, the cabbage information IAS3 included in the photograph analyzing information IAS is recognized as a keyword, and the word indicating “cabbage” is generated as the keyword key 4.

Also, the keyword generating unit 32 recognizes “curry” from the curry information IAC2 included in the photograph analyzing information IAC, and generates the keyword key 5 of the word “curry”.

Specifically, the curry information IAC2 indicating the meal category is recognized itself as the keyword, and the word indicating “curry” is generated as the keyword key 5.

Also, the keyword generating unit 32 recognizes “curried rice” from the curry information IAC2 and the rice information IAC7 included in the photograph analyzing information IAC, and generates the keyword key 6 of the words “curried rice”.

Specifically, the meal name of “curried rice” is recognized from the curry information IAC2 and the rice information IAC7, and the word indicating “curried rice” is generated as the keyword key 6.

Also, the keyword generating unit 32 recognizes “summer vegetables” from the pumpkin information IAC3, eggplant information IAC4, asparagus information IAC5, and lotus root information IAC6 included in the photograph analyzing information IAC, and generates the keyword key 7 of the words “summer vegetables”.

Specifically, a common attribute of “summer vegetables” is recognized from the pumpkin information IAC3, eggplant information IAC4, asparagus information IAC5, and lotus root information IAC6, and the word indicating “summer vegetables” is generated as the keyword key 7. Note that if there is photograph related information indicating an ingredient that covers a large region, out of the ingredients of the meal (i.e. curry), this information may be employed as the keyword. In the present case, there are no ingredients that cover a large region, so all of the ingredients are generated as keywords in parallel.

Also, the keyword generating unit 32 recognizes “low calorie” from the curry information IAC2 and 500 kcal information IAC8 included in the photograph analyzing information IAC, and generates the keyword key 8 of the words “low calorie”.

Specifically, 500 kcal is low calorie as compared to typical curry that is 700 kcal, so is recognized as “low calorie”, and the word indicating “low calorie” is generated as the keyword key 8. Note that the 20 kcal information IAS4 included in the photograph analyzing information IAS is recognized as having a small difference in calories from the typical salad calories, so the 20 kcal information IAS4 is not used to generate a keyword.

Also, the keyword generating unit 32 recognizes “lunch” from the CC restaurant information IB2 and the 2008/08/15 12:10 information IB3 included in the meal photograph information IAA1 and photograph added information IB that are included in the photograph analyzing information IAA, and generates a keyword key 9 of the word “lunch”.

Specifically, in the case there is photograph related information that satisfies a rule in the photograph related information of “shooting date/time is the lunch timeframe, the name of the shooting location is a restaurant name, and the photograph is a photograph of a meal”, “lunch” is recognized therefrom, and a word indicating “lunch” is used as a keyword. In the present case, the meal photograph information IAA1, CC restaurant information IB2, and 2008/08/15 12:10 information IB3 satisfy the rule, whereby “lunch” is recognized, and the word indicating “lunch” is generated as the keyword key 9.

Also, the keyword generating unit 32 recognizes “CC restaurant” from the CC restaurant information IB2 included in the photograph added information IB, and generates a keyword 10 of the words “CC restaurant”.

Specifically, photograph related information indicating a proper noun such as the name of a restaurant is useful in describing the target, and can therefore be used without change as the keyword. In the present case, the CC restaurant information IB2 indicates a proper noun, whereby the word indicating the “CC restaurant” is generated as the keyword key 10.

Also, the keyword generating unit 32 recognizes “summer” from the 2008/08/15 12:10 information IB3 included in the photograph added information IB, and generates keyword key 11 of the word “summer”.

Specifically, the photograph related information indicating the shooting date/time is simply converted into the four seasons, and used as the keyword. In the present case, the 2008/08/15 12:10 information IB3 is converted into the four seasons and “summer” is recognized, and the word indicating “summer” is generated as the keyword key 11.

Also, the keyword generating unit 32 recognizes “shop where a regular” from the CC restaurant information IB2 included in the photograph added information IB and the message information IDS1 of “shooting a photograph at CC restaurant for the fifth time this month” included in the photographer/contributor information IDS, and generates keyword key 12 of the words “shop where a regular”.

Specifically, the shop being a “shop where a regular” is recognized from the photograph related information indicating position information and the photograph related information indicating that the contributor frequently goes to CC restaurant, and the words indicating “shop where a regular” is generated as the keyword key 12.

Also, the keyword generating unit 32 recognizes “favorites” from the curry information IAC2 included in the photograph analyzing information IAC and the message information IDS2 of “favorite food is curry” included in the photographer/contributor information IDS, and generates keyword key 13 of the word “favorites”.

Specifically, and the meal being a “favorite” is recognized from the curry subject C being included as a subject of the photograph P1, and photograph related information that a favorite food of the contributor is curry, and the word “favorites” is generated as the keyword key 13.

Also, the keyword generating unit 32 recognizes “Mr. A also enjoys” from the message information IC1 of “Mr. A registered in favorites” included in the photograph attached information IC and the message information IDR1 of “Knows Mr. A” included in the viewer/viewing environment information IDR, and generates keyword key 14 of the words “Mr. A also enjoys”.

Specifically, “Mr. A also enjoys” is recognized from the photograph related information of “Mr. A registered photograph P1 in favorites” and the photograph related information of “Knows Mr. A”, and the words indicating “Mr. A also enjoys” is generated as the keyword key 14. Note that in the case that the viewer does not know Mr. A, such a keyword is not generated. Also, the message information IC2 of “‘Looks good’ by Ms. B” included in the photograph attached information IC indicates that Ms. B has attached a comment to the photograph P1. However, from the message information IDR2 of “Does not know Ms. B” included in the viewer/viewing environment IDR, recognition is made that information relating to Ms. B is not pertinent to the viewer, and a keyword relating to Ms. B is not generated.

### Display Text String Candidates

As described above, upon the keywords illustrated in FIG. 5 being generated by the keyword generating unit 32 (step S25), the display text string candidates such as illustrated in FIG. 6 are generated by the display text string candidate generating unit 33 (step S26).

FIG. 6 is a diagram illustrating an example of the display text string candidates generated by the display text string candidate generating unit 33 in the processing in step S26.

On the left side of FIG. 6, examples of keywords generated by the keyword generating unit 32 are illustrated. On the right side of FIG. 6, examples of display text string candidates generated based on the keywords are illustrated.

The display text string candidate generating unit 33 generates the display text string candidate DW1 of “cabbage salad” from the keyword key3 of the word “salad” and the keyword key 4 of the word “cabbage”.

Specifically, from the word “salad” indicated by the keyword key 1 and the word “cabbage” indicated by the keyword key 2, a text string of “cabbage salad” which is a type of salad is generated as the display text string candidate DW1.

Also, the display text string candidate generating unit 33 generates the display text string candidate DW2 of “salad and curry lunch” from the keyword key 3 of the word “salad”, the keyword key 5 of the word “curry”, and the keyword key 9 of the word “lunch”.

Specifically, as a description of the word “lunch” indicated by the keyword key 3, the word “salad” indicated by the keyword key 1 and the word “curry” indicated by the keyword key 5, which make up “lunch”, are connected. Thus, the text string of “salad and curry lunch” as a description of the lunch is generated as the display text string candidate DW2.

Also, the display text string candidate generating unit 33 generates the display text string candidate DW3 of “curry shop where a regular” from the keyword key 6 of the words “curried rice” and the keyword key 12 of the words “shop where a regular”.

Specifically, a word describing the target “curried rice” itself indicated by the keyword key 6, and a word defining the target “shop where a regular” itself indicated by the keyword key 12, are connected. Thus, as description to define the curried rice, the text string “curried rice at shop where a regular” is generated as the display text string candidate DW3.

Also, the display text string candidate generating unit 33 generates the display text string candidate DW4 of “low calorie summer vegetable curry” from the keyword key 5 of the word “curry”, the keyword key 7 of the words “summer vegetables”, and the keyword key 8 of the words “low calorie”.

Specifically, a word describing the target “curry” indicated by the keyword 5, and words which modify the target, which are “summer vegetables” indicated by the keyword key 7 and “low calorie” indicated by the keyword key 8, are connected. Thus, the text string “low calorie summer vegetable curry”, as a type of curry, is generated as the display text string candidate DW4.

Also, the display text string candidate generating unit 33 generates the display text string candidate DW5 of “Mr. A recommends curry at CC restaurant”, from the keyword key 5 of the word “curry”, the keyword key 10 of the words “CC restaurant”, and the keyword key 14 of the words “Mr. A also enjoys”.

Specifically, keywords are inserted into a template where “<name of person registered in favorites> recommends <noun describing target> at <location>”. In the present case, the word “Mr. A” from “Mr. A also enjoys” indicated by the keyword key 14 is inserted as the <name of person registered in favorites>. Also, the word “curry” indicated by the keyword key 5 is inserted as the <noun describing target>. Also, the words “CC restaurant” indicated by the keyword key 10 is inserted as the “<location>”. Thus, the text string “Mr. A recommends curry at CC restaurant” is generated as the display text string candidate DW5.

### Selection of Display Text String Candidate

Further, as described above, upon the display text string candidate illustrated in FIG. 6 being generated by the display text string candidate generating unit 33 (step S26), the display text string is selected by the display text string selecting unit 34 (step S27), as illustrated in FIG. 7.

FIG. 7 is a diagram illustrating an example of the display text string selected by the display text string selecting unit 34 in the processing in step S27.

Examples of photograph related information obtained by the photograph related information obtaining unit 31 is illustrated on the left side of FIG. 7. In the center of FIG. 7, examples of keywords used to generate the display text string candidates from the keywords generated by the keyword generating unit 32 are illustrated. Examples of display text string candidates generated by the display text string candidate generating unit 33 are illustrated on the upper right side of FIG. 7.

Also, on the lower right side of FIG. 7, a display text string DA1, which has been selected by the display text string selecting unit 34 from the display text string candidates illustrated on the upper right side of FIG. 7, is illustrated. A specific example of the flow, such as illustrated in FIG. 7, up to the display text string DA1 being selected will be described below.

Now, FIG. 7 illustrates an example of the display text string DA1 selected by the display text string selecting unit 34, in the case of a photograph, uploaded to the server 11 run by a predetermined SNS, being viewed. Also, the display text string selecting unit 34 selects the display text string DA1 according to predetermined rules. As such a predetermined rule, it is favorable to employ the rule wherein the display text string is selected based on scores calculated using the third calculating method described above. Now, according to the third calculating method, in order to fully utilize the features of the SNS, of the photograph relating information, scores appended to the photographer/contributor information, photograph attached information, and viewer/viewing environment information are greater.

Accordingly, as illustrated on the left side of FIG. 7, of the photograph relating information, greater scores are appended to the photographer/contributor information, photograph attached information, and viewer/viewing environment information. Specifically in the present example, a score of 3 is appended to each of the photographer/contributor information IDS and the photograph attached information IC, and a score of 5 is appended to the viewer/viewing environment information IDR. On the other hand, lesser scores are appended to the photograph analyzing information and photograph appending information of the photograph related information. Specifically in the present example, a score of 1 is appended to each of the photograph analyzing information IAA, IAS and IAC, and the photograph appended information IB.

Next, a score of 1 is appended to the keyword key 3 of the word “salad”, as illustrated in the center of FIG. 7. Specifically, the keyword key 3 is generated just from “salad” which is included in the salad information IAS2. Accordingly, the score of keyword key 3 employs the score of the salad information IAS2 without change. That is to say, the salad information IAS2 belongs to the photograph analyzing information IAS, whereby the score of 1 of the photograph analyzing information IAS becomes the score of the salad information IAS2, and consequently is employed as the score of the keyword key 3.

Similarly, a score of 1 is appended to the keyword key 4 of the word “cabbage”.

Similarly, a score of 1 is appended to the keyword key 5 of the word “curry”.

Also, a score of 2 is appended to the keyword key 6 of the words “curried rice”. Specifically, the keyword key 6 is generated from the curry information IAC2 and the rice information IAC7. Accordingly, the sum total of the score of the curry information IAC2 and the score of the rice information IAC7 is employed as the score of the keyword key 6. That is to say, the curry information IAC2 belongs to the photograph information IAC, so the score of 1 of the photograph analyzing information IAC becomes the score of the curry information IAC2 without change. Also, the rice information IAC7 belongs to the photograph analyzing information IAC, so the score of 1 of the photograph analyzing information IAC becomes the score of the rice information IAC7 without change. Accordingly, as a result of the score of 1 of the curry information IAC2 and the score of 1 of the rice information IAC7 being added together, a score of 2 is employed as the score of the keyword key 6.

Similarly, a score of 4 is appended to the keyword key 7 of the words “summer vegetables”.

Similarly, a score of 2 is appended to the keyword key 8 of the words “low calorie”.

Also, a score of 3 is appended to the keyword key 9 of the word “lunch”. Specifically, the keyword key 9 is generated from the meal photograph information IAA1, CC restaurant information IB2, and 2008/08/15 12:10 information IB3. Accordingly, the sum total of the score of the meal photograph information IAA1, the score of the CC restaurant information IB2, and the score of the 2008/08/15 12:10 information IB3 are employed as the score of the keyword key 9. That is to say, the meal photograph information IAA1 belongs to the photograph analyzing information IAA, so the score of 1 of the photograph analyzing information IAA becomes the score of the meal photograph information IAA1 without change. Also, the CC restaurant information IB2 belongs to the photograph appended information IB, so the score of 1 of the photograph appended information IB becomes the score of the CC restaurant information IB2 without change. Also, the 2008/08/15 12:10 information IB3 belongs to the photograph appended information IB, so the score of 1 of the photograph appended information IB becomes the score of the 2008/08/15 12:10 information IB3 without change. Accordingly, as a result of the score of 1 of the meal photograph information IAA1, the score of 1 of the CC restaurant information IB2, and the score of 1 of the 2008/08/15 12:10 information IB3 being added together, a score of 3 is employed as the score of the keyword key 9.

Similarly, a score of 1 is appended to the keyword key 10 of the words “CC restaurant”.

Similarly, a score of 4 is appended to the keyword key 12 of the words “shop where a regular”.

Similarly, a score of 8 is appended to the keyword key 14 of the words “Mr. A also enjoys”.

Next, a score of 2 is appended to the display text string candidate DW1 of “cabbage salad”, as illustrated on the upper right side of FIG. 7. Specifically, the display text string candidate DW1 is generated from the keyword key 3 of the word “salad” and the keyword key 4 of the word “cabbage”. Accordingly, the sum total of the score of the keyword key 3 and the score of the keyword key 4 is employed as the score of the display text string candidate DW1. That is to say, as a result of the score of 1 of the keyword key 3 and the score of 1 of the keyword key 4 being added together, a score of 2 is employed as the score of the display text string candidate DW1.

Similarly, a score of 5 is appended to the display text string candidate DW2 of “salad and curry lunch”.

Similarly, a score of 6 is appended to the display text string candidate DW3 of “curried rice at shop where a regular”.

Similarly, a score of 7 is appended to the display text string candidate DW4 of “low calorie summer vegetable curry”.

Similarly, a score of 10 is appended to the display text string candidate DW5 of “Mr. A recommends curry at CC restaurant”.

Upon the scores having been appended to all of the display text string candidates, the display text string selecting unit 34 selects the display text string candidate having the greatest score to be the display text string.

Specifically, in the example of FIG. 7, the display text string candidate DW5 of “Mr. A recommends curry at CC restaurant” to which the greatest score of 10 has been appended is selected as the display text string DA1.

Note that the display text string candidates not selected as the display text string, in the example in FIG. 7, the display text string candidates DW1 through DW4, are not defined in terms of the handling thereof, and may be removed from being display targets, but according to the present embodiment, are displayed so as to be superimposed as text strings to describe each subject. Such text strings that are superimposed to describe the subjects are called describing text strings.

Note that in the case there are multiple display text string candidates to which the greatest score has been appended, one of these may be randomly selected as the display text string, for example. Also, for example, the first calculating method and the third calculating method may be combined so that the longest (or shortest) text string is selected as the display text string from the display text strings to which the greatest score has been appended.

### Display Example

As described above, upon the display text string and photograph data having been transmitted, the terminal apparatus 12-2 receives the display text string and photograph data (step S42), and displays the display text string on a display or the like (step S43).

FIG. 8 is a diagram illustrating an example of the display text string and photograph displayed by the terminal apparatus 12-2.

In the example illustrated in FIG. 8, the photograph P1 provided from the server 11 used by the SNS (e.g. photograph sharing service) that the user of the terminal apparatus 12-2 uses.

As illustrated in FIG. 8, the display text string DA1 of “Mr. A recommends curry at CC restaurant” is displayed above the photograph P1 as the title of the photograph P1. Also, a descriptive text string as to the physical object images included in the photograph P1 recognized by the photograph analyzing information obtaining unit 41, i.e., each of the salad subject S and curry subject C, is displayed. Specifically, a descriptive text string DA11 of “cabbage salad” (equivalent of the display text string candidate DW1 in FIG. 7) is displayed so as to be superimposed on the region where the salad subject S is displayed. Also, a descriptive text string DA12 of “low calorie vegetable curry” (equivalent of the display text string candidate DW4 in FIG. 7) is displayed so as to be superimposed on the region where the curry subject C is displayed. Note that the display timing of the descriptive text string as to the subject included in the photograph P1 is not particularly defined, but according to the present embodiment, the time when the cursor of a pointing device such as a mouse or the like of the terminal device 12-2 is disposed over the region where each subject is displayed.

A comment that the user of the SNS has written in as to the photograph P1 is displayed below the photograph P1 on the display 51. In the example in FIG. 8, “I have registered in favorites” is displayed as the comment CMA of Mr. A. Also, “Looks good” is displayed as the comment CMB of Ms. B. This information is obtained as the photograph attached information of the photograph P1. That is to say, message information IC1 of “Mr. A has registered in favorites”, which is included in the photograph attached information IC of the photograph P1 is obtained from the comment CMA of Mr. A. Also, message information IC2 of “‘Looks good’ by Ms. B”, which is included in the photograph attached information IC of the photograph P1 is obtained from the comment CMB of Ms. B.

When the photograph P1 is viewed by the user of the terminal apparatus 12-2, a display text string to describe the overall photograph P1 and a descriptive text string to describe each of the subjects C and S included in the photograph P1 are displayed. Consequently, the user of the terminal apparatus 12-2 can readily recognize the overall photograph P1 description and the name and description of each of the subjects C and S included in the photograph P1. Thus, the user of the terminal apparatus 12-2 can input an appropriate comment in a comment input box CMI disposed on the display 51, as to the photograph P1 or the subject C or subject S included in the photograph P1.

Thus, with the text string automatic generating system 1, in the case of the user of the terminal apparatus 12 viewing the photograph P1, the photograph P1 together with a text string serving as a description thereof are displayed. In the case of a text string serving as the description of the photograph P1 being generated, information appended to the photograph P1, information attached to the photograph P1, and information of the photographer or contributor and the like is used. Accordingly, for example, corresponding to the timing of the contributor or viewer responding, or the timing of the viewing, display text string candidates that vary by user can be generated. Also, display text string is selected and displayed from such display text string candidates. The display text string thus displayed can be understood has being individualized for each user, and according to the extent of individualization, each user can become familiar and understand more readily.

### Second Embodiment

With the first embodiment, in the case that photograph data (data other than data uploaded from the terminal apparatus 12) recorded on the server 11 is obtained by a predetermined terminal apparatus 12, the display text string to be displayed on the terminal apparatus 12 is generated. In this case, the displayed display text string can change according to the viewer or can change according to the timing of viewing. According to a second embodiment, in the case that photograph data is uploaded to the server 11, one or more display text string candidates are generated and displayed together with the photograph on the terminal apparatus 12. In this case, the person uploading the photograph (i.e. the contributor) can select the display text string to be displayed together with the photograph from the one or more display text string candidates displayed on the terminal apparatus, by operating the terminal apparatus 12.

Note that the configuration of the server 11 according to the second embodiment is similar to the first embodiment illustrated in FIG. 2. Accordingly, the description thereof will be a repeat, and so will be omitted.

### Automatic Generating Processing of Display Text String Candidates at Time of Uploading Photograph

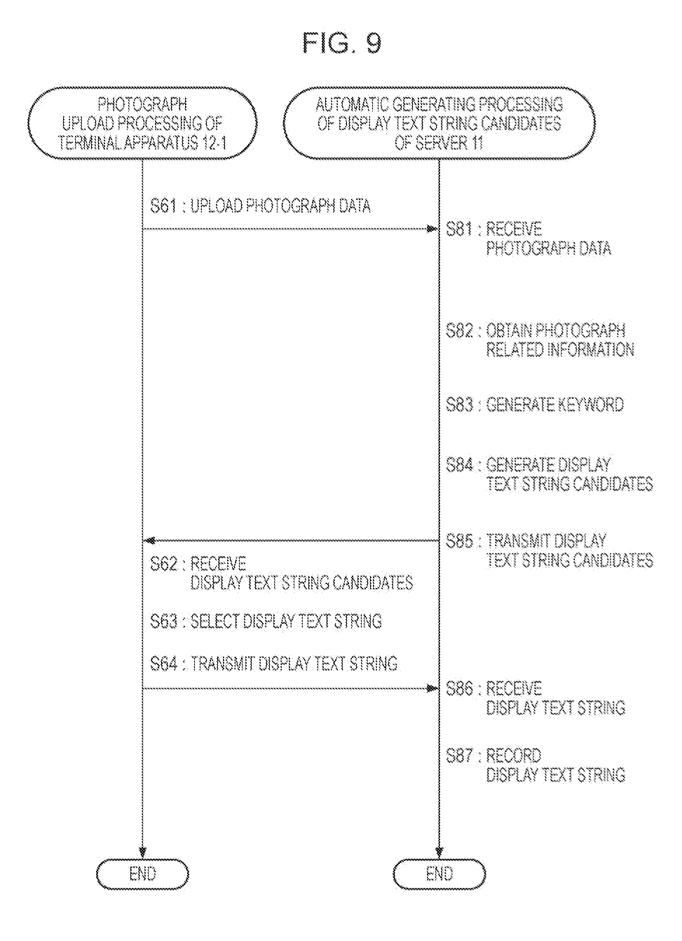

First, the relation between the server 11 and terminal apparatus 12, in the case that photograph data is uploaded to the server 11 by the user operating a predetermined terminal apparatus 12, will be described with reference to FIG. 9.

FIG. 9 is a flowchart describing the relation of processing between the server 11 and terminal apparatus 12.

In the example in FIG. 9, photograph data is uploaded to the server 11 by a predetermined terminal apparatus 12 (terminal apparatus 12-1 in the example in FIG. 9). One or more display text string candidates are automatically generated on the server 11. Now, processing executed by the terminal apparatus 12-1 is called photograph uploading processing. Also, the processing executed by the server 11 is called automatic generating processing of display text string candidate at time of uploading photograph.

In step S61, the terminal apparatus 12-1 uploads the photograph data onto the server 11.

That is to say, from the perspective of the server 11, in step S81 the communication unit 21 of the server 11 receives the photograph data from the terminal apparatus 12-1.

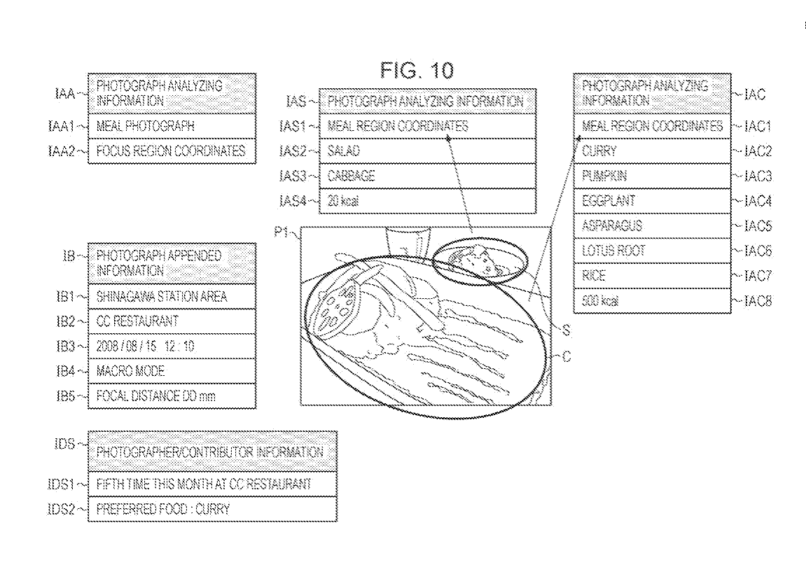

In step S82, the photograph related information obtaining unit 31 of the server 11 obtains the photograph related information related to the photograph data received in the processing in step S81. The obtained photograph related information will be described with reference to FIG. 10.

### Photograph Related Information

Upon the photograph data being received (step S81), the photograph related information such as illustrated in FIG. 10 is obtained by the photograph related information obtaining unit 31 (step S82).

FIG. 10 is a diagram illustrating an example of photograph related information obtained by the photograph related information obtaining unit 31 in the processing in step S82.

The photograph P1 illustrated in FIG. 10 is a photograph corresponding to the data that is transmitted by the terminal apparatus 12-1 and received by the server 11 in the processing in step S81. The curried rice subject C and the salad subject S are included in the photograph P1, similar to the example in FIG. 4.

Now, the photograph related information obtained in the processing in step S82 is basically similar to the photograph related information (see FIG. 4) obtained in the processing in step S24 of the automatic generating processing of the display text string at the time of photograph viewing on the server 11 according to the first embodiment.

However, according to the first embodiment, the photograph P1 that is uploaded to the server 11 by another terminal apparatus 12 (terminal apparatus 12-1) is viewed on a predetermined terminal apparatus 12 (terminal apparatus 12-2). That is to say, the contributor of the photograph P1 (note that the contributor may not be the same person as the photographer) and the viewer of the photograph P1 are different persons. Conversely, according to the second embodiment, the photograph P1 that is uploaded to the server 11 by the user of the terminal apparatus 12-1 is viewed by user of the terminal apparatus 12-1 himself. That is to say, the contributor of the photograph P1 (note that the contributor may not be the same person as the photographer) and the viewer of the photograph P1 are the same person. Accordingly, viewer/viewing environment information IDR relating to the viewer and viewing environment are not obtained by the viewer/viewing environment information obtaining unit 45.

Further, in the case of uploading photograph data, the photograph still does not belong to the community, so tags and comments and the like are not appended. Accordingly, photograph attached information IC is not obtained by the photograph attached information obtaining unit 43.

Thus, according to the second embodiment, viewer/viewing environment information IDR and photograph attached information IC is not included in the photograph related information obtained by the photograph related information obtaining unit 31.

That is to say, as illustrated in FIG. 10, just the photograph analyzing information IAA, IAS, IAC, photograph appending information IB, and photographer/contributor information IDS is included in the photograph related information obtained by the photograph related information obtaining unit 31 in the processing in step S82. The description thereof will be repetitive so will be omitted.

Returning to the description of FIG. 9, upon the photograph related information is obtained in the processing in step S82, the keyword generating unit 32 of the server 11 generates keywords based on the photograph related information obtained in the processing in step S82.

Now, the keywords generated by the processing in step S83, are basically similar to the keywords generated in the processing in step S25 (see FIG. 5) of the display text string automated generating processing on the server 11 according to the first embodiment.

However, according to the second embodiment, the viewer/viewing environment information IDR and photograph attached information IC are not obtained in the processing in step S82. Accordingly, generating of keywords using the viewer/viewing environment information IDR and photograph attached information IC is not performed by the keyword generating unit 32.

That is to say, of the keywords illustrated in FIG. 5, the keyword key 14 of the words “Mr. A also enjoys” generated from the message information IC1 of “Mr. A has registered in favorites” included in the photograph attached information IC and the message information IDR1 of “knows Mr. A” included in the viewer/viewing environment information IDR, is not included in the keywords generated in the processing in step S83.

Returning to the description of FIG. 9, upon the keywords being generated in the processing in step S83, in step S84 the display text string candidate generating unit 33 of the server 11 generates the display text string candidates using the keywords generated in the processing in step S83.

Now, the display text string candidates generated in the processing in step S84 are basically similar to the display text string candidates (see FIG. 6) generated in the processing in step S26 of the display text string automated generating processing of the server 11 according to the first embodiment.

However, according to the second embodiment, generating of keywords using the viewer/viewing environment information IDR and photograph attached information IC is not performed in the processing in step S83. Accordingly, generating of the display text string candidates using the keyword generated based on the viewer/viewing environment information IDR and photograph attached information IC is not performed by the display text string candidate generating unit 33.

That is to say, of the display text string candidates illustrated in FIG. 6, the display text string candidate DW5 of “Mr. A recommends curry at CC restaurant” generated using the keyword key 14 of the word “Mr. A also enjoys”, which is generated based on the viewer/viewing environment information IDR and photograph attached information IC, is not included in the display text string candidates generated in the processing in step S84.

Returning to the description of FIG. 9, upon the display text string candidate being generated in the processing in step S84, the communication unit 21 of the server 11 transmits the display text string candidate generated in the processing in step S84 to the terminal apparatus 12-2 in step S85.

Upon the display text string candidates being transmitted, the terminal apparatus 12-1 executes processing in step S62. That is to say, in step S62, the terminal apparatus 12-1 receives the display text string candidates.

In step S63, the terminal apparatus 12-1 selects the display text string. That is to say, the terminal apparatus 12-1 displays multiple display text string candidates received in the processing in step S62 on the display 51, and selects the display text string therefrom according to the user operations.

### Selection of the Display Text String

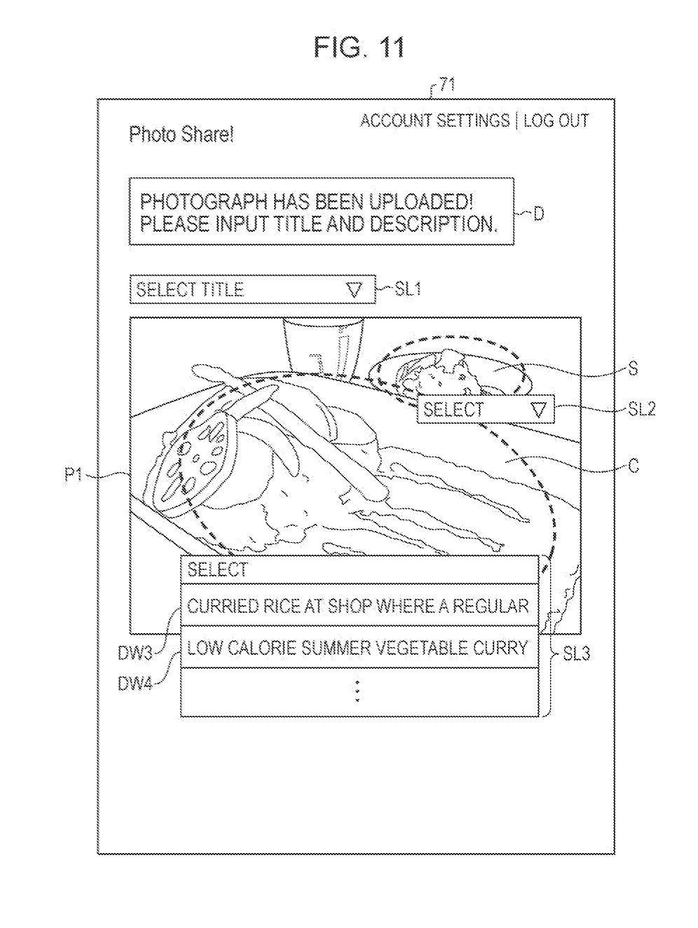

FIG. 11 is a diagram illustrating an example of an operating screen for the user to select the display text string from multiple display text string candidates.

In the example illustrated in FIG. 11, the photograph P1 which is to be uploaded to the server 11 from the terminal apparatus 12-1 is displayed on the display 71 of the terminal apparatus 12-1 itself.

As illustrated in FIG. 11, an instructional message D of “Your photograph has been uploaded!Please input a title and description” is displayed on the upper portion of the display 71. According to the instructional message D, the user inputs a title and description of the photograph P1 by operating the terminal apparatus 12-1.

Specifically, a selection box SL1 with the instructional message of “please select a title” displayed is disposed above the photograph P1. Upon the user using the cursor of the pointing device of the terminal apparatus 12-1 to select an upside-down triangular mark in the selection box SL1, the display text string candidates that can be selected as the title of the photograph P1 are displayed (unshown). Accordingly, the user selects the display text string to be displayed on another terminal apparatus 12 as the title of the photograph P1 from the displayed display text string candidates. The selected display text string is recorded on the server 11 as the title of the photograph P1, as will be described later.

Similarly, a selection box SL2 with the instructional message of “please select” displayed is disposed in the region where the salad subject S is displayed on the photograph P1. Upon the upside-down triangular mark in the selection box SL2 being selected, the display text string candidates that can be selected as the description of the salad subject S are displayed (unshown). Accordingly, the user selects the display text string to be displayed on another terminal apparatus 12 as the description of the salad subject S from the displayed display text string candidates. The selected display text string is recorded on the server 11 as the description of the salad subject S, as will be described later.

Similarly, a selection box SL3 with the instructional message of “please select” displayed is disposed in the region where the curry subject C is displayed on the photograph P1. Upon the upside-down triangular mark in the selection box SL3 being selected, the display text string candidates that can be selected as the description of the curry subject C are displayed, as illustrated in FIG. 11. Specifically, the display text string candidate DW3 of “curried rice at a shop where a regular” and the display text string candidate DW4 of “low calorie summer vegetable curry” are displayed in the selection box SL3 as descriptions of the curry subject C. Accordingly, the user selects the display text string to be displayed on another terminal apparatus 12 as the description of the curry subject C from the displayed display text string candidates. The selected display text string is recorded on the server 11 as the description of the curry subject C, as will be described later.

Note that the display text string of the photograph P1 can change depending on whether the viewer of the photograph P1 knows the user of the terminal apparatus 12-1, so at least a portion of the display text string candidates that are to be selection candidates may be changed appropriately.

Also, in the case that many display text string candidates are generated by the processing in steps S82 through S84, the user may have difficulty selecting the text string from the display text string candidates displayed in the selection boxes SL1 through SL3. In such a case, as described with the first embodiment, the number of displayed display text string candidates may be reduced a certain amount by selecting the display text string with the display text string selecting unit 34. Also, using the display text string selection by the display text string selecting unit 34, the display text string candidate having the highest score, for example, may be arranged beforehand to be displayed in the selection boxes SL1 through SL3. In this case, the user can readily change the display text string candidate displayed beforehand into another display text string candidate. For example, an arrangement may be made where the user can change the display text string candidate displayed beforehand into another display text string candidate, by selecting the upside-down triangle marks in each of the selection boxes SL1 through SL3.

Also, the user may correct the characters in the display text string candidates, and may create new display text string candidates.

Returning to the description in FIG. 9, upon the display text string being selected in the processing in step S63, in step S64 the terminal apparatus 12-1 transmits the selected display text string to the terminal apparatus 12-1. In the present case, the display text strings selected in the selection boxes SL1 through SL3 are transmitted to the server 11.

Upon the display text string being transmitted, the server 11 receives the display text string in step S86.

In step S87, the server 11 records the display text string received in step S86. That is to say, in the present case, the display text string selected as the title of the photograph P1 in selection box SL1, the display text string selected as the description of the salad subject S in selection box SL2, and the display text string selected as the description of the curry subject C in selection box SL3 are each recorded.

Thus, the processing of the server 11 and terminal apparatus 12 is ended.

Accordingly, in the case of the user of another terminal apparatus 12 viewing the photograph P1, the display text string selected as the title of the photograph P1 in selection box SL1, the display text string selected as the description of the salad subject S in selection box SL2, and the display text string selected as the description of the curry subject C in selection box SL3, together with the photograph P1, are each displayed on the other terminal apparatus 12.

Thus, according to the text string automated generating system 1, in the case of the terminal apparatus 12 uploading the photograph P1, the user only has to perform simple operations such as selecting the display text string displayed together with the photograph P1, from the multiple display text string candidates displayed on the terminal apparatus 12 itself. Accordingly, the user can omit operations that take time, such as creating an original descriptive phrase of the photograph P1.

### Third Embodiment

According to a third embodiment, the terminal apparatus 12 is a portable terminal that a user can freely carry about, such as a cellular phone or the like. The terminal apparatus 12 uses an application to use the text string automatic generating system 1, whereby services such as described below can be received.

If a menu at a restaurant overseas is viewed, the writing is in the local language, so specific language content may be difficult to understand. In such a case, the user of the terminal apparatus 12 operates the terminal apparatus 12 to use an application, whereby the content of the menu can be found out. Hereafter, such an application is called a menu translating application. However, it is important to note that “translation” here is not generally performed linguistic translation processing, but translation that is executed by image analysis with the server 11 and terminal apparatus 12 working together.

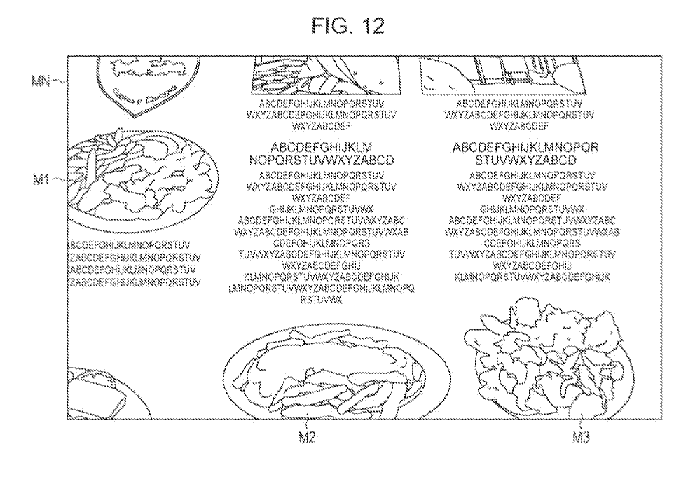

FIG. 12 is a diagram illustrating an example of a menu MN in a restaurant overseas.

As illustrated in FIG. 12, the menu MN has meal photographs M1 through M3, and descriptive statements of the meal photographs M1 through M3 written in the local language. Thus, let us say that, while descriptive statements are written for each of the meal photographs M1 through M3, the statements are written in the local language, so the user of the terminal apparatus 12 does not understand the specific content of the meal.

In such a case, the terminal apparatus 12 shoots the menu MN according to operations by the user, and uploads the data of the shot photograph to the server 11. The server 11 then analyzes the data of the meal photographs M1 through M3 included in the menu MN, and generates the names and descriptions of the meal photographs M1 through M3 as display text strings in the native language of the user. The server 11 transmits the generated display text strings to the terminal apparatus 12. The terminal apparatus 12 displays the received display text strings as names and descriptions of the meal photographs M1 through M3. Thus, the user of the terminal apparatus 12 can understand the specific names and descriptions of the meals in his native language.

Note that the configuration of the server 11 of the third embodiment is similar to the first embodiment illustrated in FIG. 2. Accordingly, the description thereof will be repetitive so will be omitted.

### Automatic Generation of Display Text String

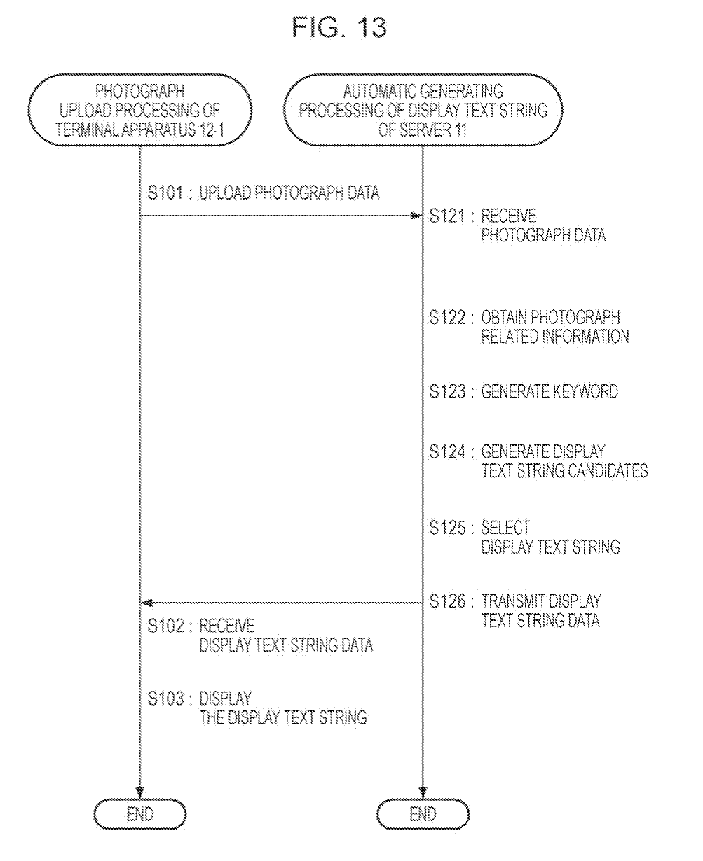

First, the relation of processing between the server 11 and terminal apparatus 12 in the case of the menu translating application being used by the user of a predetermined terminal apparatus 12 will be described with reference to FIG. 13.

FIG. 13 is a flowchart describing the relation of processing between the server 11 and terminal apparatus 12.

In the example in FIG. 13, the photograph data of the menu MN is uploaded to the server 11 by the terminal apparatus 12-1 using the menu translation application. On the server 11, one or more display text strings are automatically generated and transmitted to the terminal apparatus 12-1. Now, hereinafter the processing executed by the terminal apparatus 12-1 will be called the photograph uploading processing. Also, the processing executed by the server 11 will be called the display text string automatic generating processing.

In step S101, the terminal apparatus 12-1 uploads the photograph data of the menu MN to the server 11.

That is to say, from the perspective of the server 11, the communication unit 21 of the server 11 receives the photograph data of the menu MN which is from the terminal apparatus 12-1 in step S121.

In step S122, the photograph related information obtaining unit 31 of the server 11 obtains photograph related information related to the photograph data of the menu MN received with the processing in step S121. That is to say, the photograph related information obtaining unit 31 obtains photograph related information relating to the data of the meal photographs M1 through M3 included on the menu MN.

In the present case, the photograph data of the menu MN uploaded to the server by the terminal apparatus 12-1 is viewed with the terminal apparatus 12-1. That is to say, the contributor of the photograph of the menu MN (note that the contributor may not be the same person as the photographer) and the viewer of the photograph of the menu MN is the same person. Accordingly, the viewer/viewing environment information IDR relating to the viewer and viewing environment is not obtained by the viewer/viewing environment obtaining unit 45.

Further, in the case of the photograph data of the menu MN being uploaded, tags, comments, and the like are not appended since the photograph does not belong to the community. Accordingly, the photograph attached information IC is not obtained by the photograph attached information obtaining unit 43.

Thus, according to the third embodiment, similar to the second embodiment, the viewer/viewing environment information IDR and the photograph attached information IC are not included in the photograph related information obtained by the photograph related information obtaining unit 31.

That is to say, just the photograph analyzing information IAA, IAS, and IAC, photograph appending information IB, and photographer/contributor information IDS are included in the photograph related information obtained by the photograph related information obtaining unit 31 in the processing in step S122. Description thereof will be repetitive so will be omitted.

In step S123, the keyword generating unit 32 of the server 11 generates keywords based on the photograph related information obtained in the processing in step S122.

In the present case, the viewer/viewing environment information IDR and the photograph attached information IC are not obtained in the processing in step S122. Accordingly, generating keywords using the viewer/viewing environment information IDR and the photograph attached information IC is not performed by the keyword generating unit 32.

That is to say, the keywords generated in the processing in step S123 do not include keywords that are generated using the photograph attached information IC and the viewer/viewing environment information IDR.

In step S124, the display text string candidate generating unit 33 of the server 11 generates display text string candidates using the keywords generated in the processing in step S123.

In the present case, generating of keywords using the viewer/viewing environment information IDR and the photograph attached information IC is not performed in the processing in step S123. Accordingly, generating of display text string candidates using keywords that have been generated based on the viewer/viewing environment information IDR and the photograph attached information IC is not performed by the display text string candidate generating unit 33.

In step S125, the display text string selecting unit 34 of the server 11 selects a display text string from the display text string candidates generated in the processing in step S124.

In the present case, the display text string selecting unit 34 selects a display text string according to predetermined rules. As such a predetermined rule, it is favorable to employ the rule wherein the display text string is selected based on scores calculated using the first calculating method described above. This is because with the present embodiment, the terminal apparatus 12-1 is a cellular phone for example, whereby the display area is small, and the display region for the display text string is limited. Accordingly, it is favorable for the first calculating method is used wherein scores are calculated according to the length of the text strings of the display text string candidates. That is to say, the display text string candidate having the shortest text string is selected from the display text string candidates generated in the processing in step S124.

In step S126, the communication unit 21 of the server 11 transmits, to the terminal apparatus 12-1, the data of the display text string selected in the processing in step S125.

Upon the display text string data being transmitted, the terminal apparatus 12-1 executes the processing in step S102. That is to say, in step S102 the terminal apparatus 12-1 receives the display text string data.

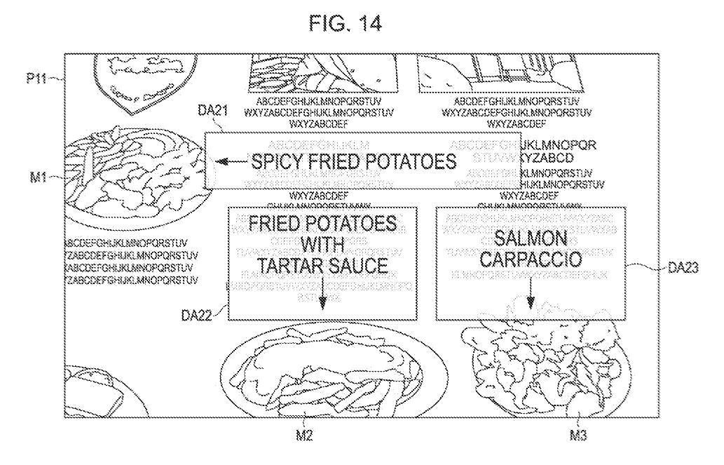

In step S103, the terminal apparatus 12-1 displays the display text string. The display text string displayed on the terminal apparatus 12-1 will be described with reference to FIG. 14.

Display Text String Superimposed onto Photograph of Menu MN

FIG. 14 is a diagram illustrating and example of a display text string that is superimposed onto a photograph P11 of the menu MN.

As illustrated in FIG. 14, descriptive text strings to describe each of the meals in the meal photographs M1 through M3 (i.e. the native language of the user, in the present example this is a text string in English) are superimposed and display on the photograph P11 of the menu MN. Specifically, a descriptive text string DA21 of “Spicy potato fries” in English is displayed as to the menu photograph M1. Also, a descriptive text string DA22 of “Potato fries with tartar sauce” in English is displayed as to the menu photograph M2. Also, a descriptive text string DA23 of “Salmon Carpaccio” in English is displayed as to the menu photograph M3.

In the case that the processing capability of the terminal apparatus 12-1 is low, and superimposing the descriptive text strings DA21 through DA23 on the photograph P11 of the menu MN for display is difficult, the processing may be performed on the server 11. That is to say, in the processing in step S126 the communication unit 21 may transmit the data, where the descriptive text strings DA21 through DA23 is superimposed onto the photograph P11 of the menu MN, to the terminal apparatus 12-1. In the present case, the terminal apparatus 12-1 displays the received data of the photograph P11 of the menu MN, whereby the descriptive text strings DA21 through DA23 can also be displayed simultaneously.

Thus, according to the present embodiment, the photograph P11 of the menu MN described in a first language (for example a foreign language as to the user) by the terminal apparatus 12-1 and transmitted to the server 11. On the server 11, the names and descriptions and the like of the meals included on the menu MN are generated as display text strings in a second language (for example the native language of the user, by image analysis as to the subjects included in the photograph P11. Thus, even if (linguistic) translating software that translates from a first language to a second language is not installed, the terminal apparatus 12-1 can display the names and descriptions and the like of the meals included in the menu MN, superimposed, in the second language, as to the photograph P11 of the menu MN which has been described in the first language.

That is to say, even with the user not installing high capacity translating software taking high loads, and in some cases high costs, as to the terminal apparatus 12-1, and even without carrying other electronic devices such as an electronic dictionary, the names and descriptions and the like of the meals included in the menu MN can be recognized in a second language (native language), just using simple operations as to the terminal apparatus 12-1.

Note that in the example described above, the data of the display text string selected by the display text string selecting unit 34 is transmitted to the predetermined terminal apparatus 12, and the display text string is displayed on the predetermined terminal apparatus 12. However, the state of presentation with the predetermined terminal apparatus 12 of the display text string selected by the display text string selecting unit 34 is not particularly limited to a display, and for example may be audio output. Therefore, even without a display function for example, the terminal apparatus 12 can appropriately present the display text string selected by the display text string selecting unit 34 to the user.

Specifically for example, there are cases where a portable device with camera that does not have a display function and that can be attached to a pair of glasses is employed as the predetermined terminal apparatus 12. In such a case, the data of the photograph shot by the predetermined terminal apparatus 12 is uploaded to the server 11. The serer 11 analyzes the received photograph data, and generates display text string data of the names and descriptions of the subjects included in the photograph. The server 11 then transmits the generated display text string data to the predetermined terminal apparatus 12. Upon receiving the display text string data, the predetermined terminal apparatus 12, not having a display function, outputs the display text string by audio. Thus, the user wearing the glasses to which the predetermined terminal apparatus 12 is attached can understand, via audio, the names and descriptions of the items recognized by sight (items photographs by the predetermined terminal apparatus 12).

Also, a target to be uploaded from the predetermined terminal apparatus 12 to the server 11 has been described in the examples above as photograph (i.e. still image) data, but any image data may be used, and for example moving image data may be used. Specifically for example, in the case that the predetermined terminal apparatus 12 has a shooting function for moving images, often the device will have a function to display moving images during shooting (particularly moving images without recording as a premise), in real time, called through images or live-view images. A predetermined terminal apparatus 12 having such functions can upload the through image data to the server 11.

The server 11 analyzes the received through image (moving image) data, and generates display text string data of the names and descriptions of the subjects included in the through image. The server 11 then transmits the generated display text string to the predetermined terminal apparatus 12. Upon receiving the display text string data, the predetermined terminal apparatus 12 displays a through image having the display text string superimposed onto the subject and displayed. Thus, the user can appropriately recognize the names and descriptions of the subjects during shooting of the moving image.

### Application of the Program of the Present Technology

The series of processing described above may be executed using hardware or may be executed using software.

In the case of executing the series of processing using software, a program making up the software thereof is installed onto a computer. The computer here includes computers that have dedicated hardware built in, and general-use personal computers that can execute various types of functions by having various types of programs installed therein.

For example, on the server 11 in FIG. 2, which is an example of a computer, the CPU within the control unit 23 loads the program stored in the storage unit 22 into the RAM in the control unit 23, thereby performing the above-described series of processing.

The program executed by the computer can be recorded onto and provided by a removable media 25 serving as a packaged media or the like, for example. Also, the program may be provided via a cabled or wireless transmission medium such as a Local Area Network, the Internet, and digital satellite broadcasting.

The program can be installed in the recording unit 22 of the computer by attaching the removable media 25 to the drive 24. Also, the program can be received by the communication unit 21 via a cabled or wireless transmission medium and installed in the recording unit 22. Also, the program can be installed beforehand in the ROM in the control unit 23 or the recording unit 22.

Note that the program executed by the computer may be a program in which processing is performed in a time-series manner following the order described in the present Specification, or may be a program in which processing is performed concurrently, or at a timing as appropriate when a callout is performed.

The present technology can be applied to an information processing apparatus using an SNS, for example.

The embodiments according to the present technology are not limited to the above-described embodiments, and various types of modifications can be made within the intent and scope of the present technology.

For example, the present technology can take the configuration of cloud computing which divided, shares, and processes one function with multiple devices via a network.

Also, the steps described above in the flowcharts can be executed by one device or can be divided and executed by multiple devices.

Further, in the case that multiple processing is included in one step, the multiple processing included in the one step can be executed by one device, or can be divided and executed by multiple devices.

Note that the present technology can also assume the following configurations.

(1) An information processing apparatus including

an image related information obtaining unit that obtains information relating to a predetermined image as image related information;

a keyword generating unit that generates a keyword based on the image related information obtained by the image related information obtaining unit; and

a display text string candidate generating unit that generates, as a display text string candidate, a text string serving as a candidate for display, using one or more of the keywords generated by the keyword generating unit.

(2) The information processing apparatus according to (1) above, including

a display text string selecting unit that selects a text string to be displayed as the display text string, from the display text string candidates generated by the display text string candidate generating unit.

(3) The information processing apparatus according to (1) or (2) above, including

a communication unit that correlates the display text string selected by the display text string selecting unit and the predetermined image data, and transmits to another information processing apparatus.

(4) The information processing apparatus according to any one of (1) through (3) above, wherein the display text string selecting unit further calculates scores as to each of the display text string candidates, and selects the display text string based on the scores calculated as to each of the display text string candidates.
(5) The information processing apparatus according to any one of (1) through (4) above, further including

a communication unit that receives the predetermined image data transmitted from the other information processing device,

wherein the image related information obtaining unit, the keyword generating unit, and the display text string candidate generating unit each execute processing, based on the predetermined image data received by the communication unit; and

wherein the communication unit transmits the display text string candidates generated by the display text string candidate generating unit to the other information processing apparatus.

(6) The information processing apparatus according to any one of (1) through (5) above, wherein

the image related information obtaining unit uses the analysis results of the predetermined image data to generate the image related information in a predetermined language;

and wherein the keyword generating unit generates the keywords in the predetermined language; and

and wherein the display text string candidate generating unit generates the display text string candidates in the predetermined language.

(7) The information processing apparatus according to any one of (1) through (6) above, the image related information obtaining unit further including:

an image analyzing information obtaining unit that obtains information indicating the analysis results of the predetermined image data, as image analysis information which is a type of the image related information;

an image appended information obtaining unit that obtains information appended to the predetermined image data, as image appended information which is a type of the image related information; and

a photographer-contributor information obtaining unit that obtains information about the photographer of the predetermined image or the contributor to a community to which the predetermined image belongs, as photographer-contributor information which is a type of the image related information.

(8) The information processing apparatus according to any one of (1) through (7) above, the image related information obtaining unit further including:

an image attached information obtaining unit that obtains information attached to the predetermined image, as image attached information which is a type of image related information; and

a viewer-viewing environment information obtaining unit that obtains information relating to the viewer of the predetermined image in the community to which the predetermined image belongs, or information relating to the viewing environment of the predetermined image, as viewer-viewing environment information which is a type of the image related information.

(9) The information processing apparatus according to any one of (1) through (8) above, wherein the keyword generating unit generates, as the keyword, the image related information itself, or the image related information that is converted using a predetermined rule or database.
(10) The information processing apparatus according to any one of (1) through (9) above, wherein the display text string candidate generating unit generates, as the display text string candidate, the keyword itself, a text string linking a plurality of the keywords, or the keyword that has been converted using a predetermined rule or database.

The present technology can be applied to an editing apparatus to edit content.

The present disclosure contains subject matter related to that disclosed in Japanese Priority Patent Application JP 2011-244162 filed in the Japan Patent Office on Nov. 8, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
an image related information obtaining unit that obtains information relating to a predetermined image as image related information;
a keyword generating unit that generates a keyword based on the image related information obtained by the image related information obtaining unit; and
a display text string candidate generating unit that generates, as a display text string candidate, a text string serving as a candidate for display, using one or more of the keywords generated by the keyword generating unit.

2. The information processing apparatus according to claim 1, further comprising:
a display text string selecting unit that selects a text string to be displayed as the display text string, from the display text string candidates generated by the display text string candidate generating unit.

3. The information processing apparatus according to claim 2, further comprising:
a communication unit that correlates the display text string selected by the display text string selecting unit and the predetermined image data, and transmits to another information processing apparatus.

4. The information processing apparatus according to claim 2, wherein the display text string selecting unit further calculates scores as to each of the display text string candidates, and selects the display text string based on the scores calculated as to each of the display text string candidates.

5. The information processing apparatus according to claim 1, further comprising:
a communication unit that receives the predetermined image data transmitted from the other information processing device;
wherein the image related information obtaining unit, the keyword generating unit, and the display text string candidate generating unit each execute processing, based on the predetermined image data received by the communication unit;
and wherein the communication unit transmits the display text string candidates generated by the display text string candidate generating unit to the other information processing apparatus.

6. The information processing apparatus according to claim 1, wherein
the image related information obtaining unit uses the analysis results of the predetermined image data to generate image related information in a predetermined language;
and wherein the keyword generating unit generates the keywords in the predetermined language;
and wherein the display text string candidate generating unit generates the display text string candidates in the predetermined language.

7. The information processing apparatus according to claim 1, the image related information obtaining unit further including:
an image analyzing information obtaining unit that obtains information indicating the analysis results of the predetermined image data, as image analysis information which is a type of the image related information;
an image appended information obtaining unit that obtains information appended to the predetermined image data, as image appended information which is a type of the image related information; and
a photographer-contributor information obtaining unit that obtains information about the photographer of the predetermined image or the contributor to a community to which the predetermined image belongs, as photographer-contributor information which is a type of the image related information.

8. The information processing apparatus according to claim 7, the image related information obtaining unit further comprising:
an image attached information obtaining unit that obtains information attached to the predetermined image, as image attached information which is a type of image related information; and
a viewer-viewing environment information obtaining unit that obtains information relating to the viewer of the predetermined image in the community to which the predetermined image belongs, or information relating to the viewing environment of the predetermined image, as viewer-viewing environment information which is a type of the image related information.

9. The information processing apparatus according to claim 1, wherein the keyword generating unit generates, as the keyword, the image related information itself, or the image related information that is converted using a predetermined rule or database.

10. The information processing apparatus according to claim 1, wherein the display text string candidate generating unit generates, as the display text string candidate, the keyword itself, a text string linking a plurality of the keywords, or the keyword that has been converted using a predetermined rule or database.

11. An information processing method of an information processing apparatus, the method comprising:
obtaining information relating to a predetermined image as image related information;
generating a keyword based on the obtained image related information; and
generating, as a display text string candidate, a text string serving as a candidate for display, using one or more of the generated keywords.

12. A program that causes a computer to function as:
an image related information obtaining unit that obtains information relating to a predetermined image as image related information;
a keyword generating unit that generates a keyword based on the image related information obtained by the image related information obtaining unit; and
a display text string candidate generating unit that generates, as a display text string candidate, a text string serving as a candidate for display, using one or more of the keywords generated by the keyword generating unit.
